(19) United States
(12) Patent Application Publication
(10) Pub. No.: US 2007/0107063 A1
(43) Pub. Date: May 10, 2007

(54) Method and means for writing decryption information to a storage medium, storage medium, method and means for reading data from a storage medium, and computer program

(76) Inventor: Andreas Eckleder, Karlsbad (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/501,506

(22) Filed: Aug. 9, 2006

Related U.S. Application Data
(60) Provisional application No. 60/734,904, filed on Nov. 9, 2005.

(30) Foreign Application Priority Data
Mar. 8, 2006 (EP) PCT/EP06/02133

(51) Int. Cl. H04L 9/32

(52) U.S. Cl. 726/27

(57) ABSTRACT

A concept for digital content protection makes use of a storage medium having an encrypted data content, being encrypted using a data content key such that the data content key can be decrypted using a first cryptographic method, a first-method-encrypted version of the data content key, encrypted such that it can be decrypted using a first cryptographic method media key, a second-cryptographic-method encrypted data content key, which is an encrypted representation of the data content key or the first-method-encrypted data content key, encrypted such that the data content key or the first-method-encrypted data content key can be derived from the second method encrypted data content key using a second cryptographic method media key. The data content key or the first-cryptographic-method-encrypted data content key is encrypted using a second cryptographic method, which is different from the first cryptographic method, to obtain a second-method-encrypted data content key and the second-method-encrypted data content key is stored on the medium.

### CROSS-REFERENCE TO RELATED APPLICATIONS

This application claims priority from U.S. Provisional application No. 60/734,904, which was filed on Nov. 09, 2005, and International Application No. PCT/EP2006/002133, which was filed on Mar. 8, 2006, which are both incorporated herein by reference in their entirety.

### BACKGROUND OF THE INVENTION

1. Field of the Invention

The present invention is generally related to a method for writing decryption information to a storage medium, a storage medium writer, a storage medium, a method for reading data from a storage medium, a storage medium reader and a computer program. In particular, the present invention is related to an upgrade path for DVD video copy protection.

2. Description of the Prior Art

A content scrambling system, also designated as “CSS”, is a technology used today for encrypting commercially mastered DVD video content to prevent users from creating copies of copyrighted content.

CSS uses a number of keys for controlling access to a data content stored for example on a DVD medium. A DVD protected using CSS contains a block of encrypted information, from which a CSS disc key (a media key) can be derived, if a certain secret is known to a device or media player. The actual data content of a CSS protected DVD (or at least a part of the data content on the DVD) is encrypted using CSS title keys. For this purpose, encrypted CSS title keys are stored in the sector headers of the sectors which can be decrypted by means of the CSS title keys. Further, the (encrypted) CSS title keys can be decrypted to obtain plain text CSS title keys using the CSS disc key (media key). Thus, in principle it is merely possible to properly decrypt encrypted data content on a CSS protected DVD if a respective secret required for obtaining the CSS disc key is known.

Consequently, in principle only authorized hardware or software DVD players including the respective secret can play a CSS protected DVD properly.

However, several years ago the algorithm behind CSS as well as all related communication protocols have become public knowledge, thus forfeiting all attempts to effectively protect copyrighted works from illegal copying ever thereafter.

Most DVD video equipment has been designed to work with exactly one copy protection system, namely the aforementioned CSS. It is therefore not possible to correct the problems that have arisen from the structural weaknesses of CSS without breaking compatibility with existing playback devices.

There have been several attempts to design more effective content protection technologies for DVD media, one of which is a video content protection system, also designated as VCPS. VCPS has been developed from scratch and relies on a much more advanced cryptographic algorithm called AES, also designated as “Rijndael”-algorithm. VCPS is so far unbroken and knows how to deal with multiple keys. Furthermore, VCPS includes the capability to revoke compromised secrets such that they can no longer be used for decoding copyrighted content. VCPS has been designed to encrypt DVD recording made from public TV broadcasts which have been marked using one of the states “copy never”, “copy once” and/or “encrypt but copy freely”. While VCPS is a much more advanced copy protection technology that as of today is considered secure, it cannot be used on new DVD video media as content protected using VCPS cannot be played on legacy playback devices, i.e. players that do not explicitly support VCPS copy protection.

In the following, the basic flow of encryption and decryption using the VCPS method will be described with reference to FIG. 8. For this purpose, FIG. 8 shows a schematic diagram of a key hierarchy for a VCPS system. The schematic diagram of FIG. 8 is designated in its entirety with 800.

A DVD or another storage medium using the VCPS concept contains a disc key block 810 (DKB), a unique ID 812, an encrypted unique key 814 (KU), an encrypted program key 816 (KP) and an encrypted audio-video sector 818. When recording to a DVD, the disc key block 810 is read to the recording device. The recording device then calculates a root key 830 (KR) using device ID node keys 832 and a secret known to the recording device (or recording software). Furthermore, if the DVD does not yet contain a unique ID 812, the recording device generates a random number in a random number generator 840 and stores the random number on the DVD as the unique ID 812. Furthermore, the recording devices derives disc a disc key 850 (KD) from the root key 830 and the unique ID 812. If the DVD does not yet contain an encrypted unique key 814, the recording device generates a random number 854 using a random number generator 856, wherein the random number 854 constitutes a unique key (KU). The recording device further encrypts the random number 854 (KU) using the disc key 850 (KD) and an AES encryption algorithm, and stores the encrypted unique key on the DVD. Furthermore, another random number 860 is generated in a further random number generator 862 of the recording device, wherein the further random number constitutes a program key (KP). The program key is encrypted using the unique key 854 (KU) and an AES encryption algorithm, and the encrypted program key is stored on the DVD. Audio-video data 870 are encrypted in sectors using an AES-CBC encryption algorithm, wherein a key for the encryption of the audio-video data 870 is derived by a hash operation from the program key 816 (KP) and an number bits (BP 80 . . . 95) of the audio-video data. Further, it should be noted that the audio-video data 870 is encrypted sector-wise so that the DVD comprises a number of encrypted audio-video sectors 818.

Decryption of the DVD contents is executed in an inverse way, as can be seen from the schematic diagram 800. A root key can be obtained using information of the disc key block 810 and a secret information. A disc key can be obtained using the unique ID 812 stored on a DVD and the root key (KR). Further, the disc key (KD) is used, in combination with the encrypted unique key (KU) and the encrypted program key (KP) stored on the DVD, in order to decrypt the encrypted audio-video sector 818 stored on the DVD. Thus, an encrypted audio-video pack 880 can be obtained.

For further details, regarding the VCPS video content protection system, reference is made to the document “VCPS: Video Encryption for DVD Recording; Overview of the technology; Key Block, Unique ID, Key Hierarchy, Revocation, Key Distribution” and to the document “VCPS: Video Content Protection System for the DVD+R/+RW Video Recording Format; System Description; Version 1.3; July 2005”. Both documents are for example available on the Internet under the url “http://www.licensing.philips.com/information/vcps”, or can be obtained from Philips Intellectual Property and Standards, Eindhoven, The Netherlands. The Information of the referenced documents is enclosed herewith and is related to any embodiments of the invention using the VCPS content protection system.

### SUMMARY OF THE INVENTION

In view of the above described content protection systems, it is an object of the present invention to create a concept for content protection which allows for a gradual transition from an older content protection system to a more advanced content protection system.

In accordance with a first aspect, the present invention provides a method of writing decryption information to a storage medium for storing an encrypted data content, the encrypted data content being encrypted, using a data content key, for decrypting the encrypted data content using a first encryption method, the method having the steps of: encrypting the data content key or a first-method-encrypted data content key using a second cryptographic method which is different from the first cryptographic method, to obtain a second-method-encrypted data content key; and storing on the medium the second-method-encrypted data content key, wherein the method of writing is operative to produce the storage medium such that it includes: the encrypted data, encrypted with the data content key and the first cryptographic method; the first-cryptographic-method-encrypted data content key; and the second-cryptographic-method-encrypted data content key.

In accordance with a second aspect, the present invention provides a storage medium writer for writing decryption information to a storage medium for storing an encrypted data content, the encrypted data content being encrypted, using a data content key, for decrypting the encrypted data using a first cryptographic method, the storage medium writer having: means for encrypting the data content key or a first-method-encrypted data content key using a second cryptographic method which is different from the first cryptographic method, to obtain a second-method-encrypted data content key; and means for storing on the medium the second-method-encrypted data content key, wherein the storage medium writer is adapted to be operative to produce a storage medium such that it includes: the encrypted data, encrypted with the data content key and the first cryptographic method; the first-cryptographic-method-encrypted data content key; and the second-cryptographic-method-encrypted data content key.

In accordance with a third aspect, the present invention provides a storage medium having: an encrypted data content, being encrypted using a data content key such that the data content can be encrypted using a first cryptographic method; a first-method-encrypted version of the data content key, encrypted such that it can be decrypted using a first-cryptographic-method media key; and a second-cryptographic-method encrypted data content key, which is an encrypted representation of the data content key or the first-method-encrypted data content key, encrypted such that the data content key or the first-method-encrypted data content key can be derived from the second-method-encrypted data content key using a second-cryptographic-method media key.

In accordance with a fourth aspect, the present invention provides a method of reading data from a storage medium for storing an encrypted data content, the encrypted data content being encrypted, using a data content key, for decrypting the encrypted data using a first encryption method, a first-cryptographic-method-encrypted data content key, and a second-cryptographic-method-encrypted data content key or a first-cryptographic-method-encrypted and second-cryptographic-method-encrypted data content key, the method having the steps of: checking, whether the storage medium is recorded using a first recording method or using a second recording method; and if the storage medium is recorded using the first recording method, recovering the data content key using a second-cryptographic-method media key, and decrypting the encrypted data content using the first cryptographic method and the data content key recovered using the second cryptographic method.

In accordance with a fifth aspect, the present invention provides a storage medium reader for reading data from a storage medium for storing an encrypted data content being encrypted, using a data content key, for decrypting the encrypted data using a first encryption method, a first-cryptographic-method-encrypted data content key, and a second-cryptographic-method-encrypted data content key or a second-cryptographic method-encrypted and first-cryptographic-method encrypted data content key, the storage medium reader having: means for checking, whether the storage medium is recorded using a first recording method or using a second recording method; means for recovering the data content key using a second-encryption-method media key, if the storage medium is recorded using the first recording method; and means for decrypting the encrypted data content using the first encryption method and the recovered data content key.

In accordance with a sixth aspect, the present invention provides a computer program for executing one of the above mentioned methods, when the computer program runs on a computer.

The present invention creates a method of writing decryption information to a storage medium for storing encrypted data content, the encrypted data content being encrypted using a data content key for decrypting the encrypted data using a first encryption method. The inventive method comprises encrypting the data content key or a first cryptographic method encrypted version of the data content key using a second cryptographic method, which is different from the first cryptographic method. By encrypting the data content key (or a version of the data content key encrypted using the first cryptographic method) using the second cryptographic method, a second cryptographic method encrypted data content key is obtained. Alternatively, the encrypted data content key, encrypted using the first encryption method, is re-encrypted using the second cryptographic method, such that a second (cryptographic) method encrypted and first (cryptographic) method encrypted data content key is obtained, which is also referred to as “second method encrypted data content key”. Subsequently, the second method encrypted data content key is stored on the medium.

The method of writing is further operative to produce the storage medium such that the storage medium includes encrypted data, encrypted with the data content key and using the first cryptographic method, the first method encrypted data content key and the second method encrypted data content key.

It is the key idea of the present invention that it is advantageous to produce a storage medium such that it comprises a data content key, by means of which encrypted data can be decrypted, in two different encrypted versions, encrypted using two different cryptographic methods. Thus, depending on the characteristics of a media player device or readout device, the first cryptographic method or the second cryptographic method can be applied for obtaining the information to decrypt the data content.

Conventional media player devices or media readers, capable of dealing with the first cryptographic method but not capable of applying the second cryptographic method, will accept the storage medium produced by the inventive method, as the data content key is stored on the medium in a version encrypted using the first cryptographic method (designated as “first (cryptographic) method encrypted data content key”). Thus, any old media player devices or media readers adapted to use the first cryptographic method and having available the required secret can handle with a storage medium produced using the inventive method.

However, as typically the first cryptographic method is an older or cryptographically less secure cryptographic method (when compared to the second cryptographic method), unauthorized access to the medium may be possible using conventional media player devices or media readers.

However, according to the inventive method the data content key is also stored on the medium encrypted using a second encryption method. Thus, any more advanced media player device or media reader has a chance to additionally evaluate the second method encrypted data content key. Thus, it is possible to determine, using a novel media player device or media reader, whether an access to the encrypted data content is authorized or not.

Besides, a novel media player device or media reader may be adapted to neglect the (possibly not secure) first encryption method encrypted data content key and merely use information encrypted with the second, more advanced cryptographic method in order to obtain the data content key.

According to the present invention, the data content is encrypted using the first encryption method and a data content key associated with the first cryptographic method. For this reason, conventional media player devices or media readers can access the data content. According to a key idea of the present invention, it is not necessary to also include on a storage medium another version of the data content, encrypted using the second cryptographic method. Rather, by encrypting the data content using an algorithm of the first cryptographic method, and using the second cryptographic method for a protection of a respective key, it can be achieved that a high degree of security is achieved in systems relying merely upon the second cryptographic method for obtaining the data content key.

Thus, the present invention is based on the finding that in order to prevent unauthorized access to the encrypted data content, it is sufficient to put high cryptographic effort on protecting the data content key. It was further found that storage media written according to the inventive method should be readable both on conventional and new media player devices or media readers. It has been found that in order to comply with the above described requirements it is advantageous to write to the medium a first encrypted version of the data content key, encrypted using the first encrypted encryption method (also designated as first method encrypted data content key), and another version of the data content key, encrypted using the second cryptographic method (also designated as second method encrypted data content key).

Besides, it can be expected that after a certain time the number of media players exclusively using the first encryption method will be very small. In contrast, it may be expected that after a certain time a large number of media players capable of applying the second encryption method will be on the market, and that these media players will be configured to give priority to using the second cryptographic method if they find out that information related to the second cryptographic method is available on the storage medium. Thus, new media players will only provide the data content stored on the storage medium if an authentication required by the second cryptographic method is successful.

So, new media players will play old storage media comprising no information related to the second encrypted method, and will play storage media comprising information related to the second cryptographic method provided a valid authorization according to the second cryptographic method is executed.

To summarize the above, the inventive method of writing decryption information to a storage medium provides a possibility to write to the storage medium all the information required to obtain the data content from the storage medium both using conventional media players and new media players equipped with an improved method for authentification making use of the second cryptographic method.

According to a preferred embodiment of the present invention, the first cryptographic method comprises a first cryptographic algorithm for encrypting and/or decrypting the encrypted data using the data content key, and a second cryptographic algorithm for encrypting and/or decrypting the data content key, wherein the second cryptographic algorithm is different from the first cryptographic algorithm. The second method comprises a further cryptographic algorithm for encrypting and/or decrypting the data content key or the first (cryptographic) method encrypted data content key.

In another preferred embodiment, two different media keys (e.g. disc-keys) are provided for use with the first cryptographic method and the second cryptographic method. In other words, the second cryptographic algorithm of the first cryptographic method uses a media key associated with the first cryptographic method (“first method media key”) for encryption and/or decryption, and the second cryptographic method algorithm for encrypting the data content key or the encrypted data content key uses a media key associated with the second cryptographic method (“second cryptographic method media key”).

Thus, different mechanisms or algorithms can be applied in order to obtain the media key for the first cryptographic method and the media key for the second cryptographic method. Accordingly, it can be ensured that it is cryptographically more difficult (or cryptographically more complex) to break the second cryptographic method media key than to break the first cryptographic method media key. So, an improved cryptographic security of the second cryptographic method can be exploited when making use of a medium written using the inventive method.

In other words, an improvement is achieved by the fact that the second cryptographic method is cryptographically more secure than the first cryptographic method. This is reached if the second cryptographic method algorithm for encrypting the data content key or the first method encrypted data content key is cryptographically more secure than the second encryption algorithm of the first cryptographic method. In other words, the second cryptographic method for example uses a longer key tan the first cryptographic method, or uses an algorithm with higher computational complexity (e.g. more rounds of iterative encryption).

In a further preferred embodiment, the first cryptographic method is a CSS method, while the second cryptographic method is a VCPS method. In this case, the first cryptographic algorithm of the first cryptographic method is a CSS data encryption algorithm, and the second cryptographic algorithm of the first encryption method is a CSS key encryption algorithm. The second cryptographic method algorithm for encrypting the data content key or the first method (CSS) encrypted data content key is a VCPS data encryption method or a VCPS key encryption method. By making use of the CSS cryptographic method and the corresponding algorithms, a medium written using the inventive method is compatible with almost any existing media player device or media reader. Further, advanced media players can make use of the second cryptographic algorithm and the cryptographically strong and unbroken protection of the VCPS media key (disk key). Therefore, as soon as new media player devices or media readers are available, these can take advantage of the highly secure VCPS mechanisms although the data content stored on the storage medium is encrypted using CSS data encryption algorithms, and although CSS key information is (additionally) included on the storage medium.

In another preferred embodiment, the encrypted data content key, which is used as a basis for the calculation of the second method encrypted data content key, is encrypted such that it can be decrypted using a first method media key associated with the storage medium. In other words the second method data content key is generated such that both the first cryptographic method media key and the second cryptographic method media key are required in order to obtain the plain text data content key therefrom.

In this case, the inventive method further comprises encrypting the first method media key such that it can be decrypted using a second method media key associated with the storage medium, to obtain an encrypted version of the first method media key (“second method encrypted first method media key”). The second method encrypted first method media key is then stored on the medium. Thus, a further stage of security is included in the medium. When producing the storage medium, it is not necessary to have available a decrypted version of the data content key. Rather, it is sufficient to have access to the first encryption method encrypted data content key. Besides, for writing the storage medium it is necessary to know the first cryptographic method media key, as a second method encrypted version of the first method media key is provided on the medium.

When reading the storage medium, the first cryptographic method media key can be obtained by a decryption processes according to the first cryptographic method. However, for this purpose specific information must be read out from the storage medium, which is relevant for the first cryptographic method only. In a media player device adapted to use the second cryptographic method, it may be undesirable to access an information on a storage medium, which is related to the first cryptographic method. For this reason, it is advantageous to grant access to the first encryption method media key using the second cryptographic method only, without requiring access to dedicated first method information. Accordingly, the present invention teaches to encrypt the first method media key such that it can be decrypted using the second method media key. This is another security feature, as it is assumed that the cryptographic security of the second method media key is significantly better than the cryptographic security of the first cryptographic method media key.

According to the described concept, it is unnecessary to have available at the time of writing the medium a plain text version of the content key while still giving a media reader device a chance to read the data content of the storage medium without accessing first cryptographic method information for obtaining the first cryptographic method media key.

In other words, a media reader device does not need to be able to obtain the media key according to the specification of the first cryptographic method, e.g. using prewritten information on the medium. Rather, it is sufficient to obtain the second cryptographic method media key and to perform operations according to the specification of the second cryptographic method. For this reason, the complexity of a media reader device can be reduced, and a new cryptographic media reader device can access a storage medium faster (without the need to access any storage regions dedicated to the first cryptographic method).

The described method is particularly advantageous if the first cryptographic method media is a CSS method, and the second cryptographic method is a VCPS method. In this case, a CSS media key can be obtained without using information in a prewritten region of the storage medium, as the disk key block according to the VCPS system is copied to a writable region of the medium. Thus, a reader does no longer need to read information stored in the non-writeable (stamped) region of the medium in order to achieve the data content key.

In a further embodiment, the method of writing is operative to produce a storage medium such that the first method encrypted data content key is stored in a header of a corresponding sector, and that the second method encrypted data content key is stored in a file accessible through a file system. In other words, the first method encrypted data content key is contained at certain bit positions in the sectors of the storage medium, and can therefore not be accessed directly using a file system. In particular, there is no reference pointing directly to the first method encrypted data content key.

In contrast, the second method encrypted data content key is stored in a file, wherein a link to the file is set in a file system directory. Furthermore, the file system provides a file link so that the second method encrypted content key can be accessed directly by an operating system.

Placing the second method encrypted data content key in a file (i.e. a payload data region) rather than in a sector header of the storage medium facilitates a random access by media reader devices and improves compatibility with existing media readers. The structure of the files defined by the CSS specification typically comprises a plurality of sectors and should not be amended. In contrast, adding additional information, like the second method encrypted data content key, in an additional file is advantageous with respect to backward compatibility, as conventional media reader devices make use of a file system directory in order to find the files which they require. An additional file, whose file name is different from the file names conventionally used, is therefore neglected by conventional media reader devices.

For similar reasons, it is also advantageous to store the second method encrypted first method media key in a dedicated (key-information-only) file accessible over the file system.

The present invention further comprises a storage medium writer for writing decryption information to a storage medium. The storage medium writer comprises means for executing the steps described with respect to the inventive method of writing decryption information to a storage medium.

Further, the present invention creates a storage medium comprising an encrypted data content, being encrypted using a data content key such that the data content can be decrypted using a first encryption method. The medium further comprises an encrypted version of the data content key, encrypted such that it can be decrypted using a first cryptographic method media key (“first method encrypted data content key”). Besides, the storage medium comprises a second cryptographic method encrypted data content key, which is an encrypted representation of the data content key or the first method encrypted data content key, encrypted such that the data content key or the first method encrypted data content key can be derived from the second method encrypted data content key using a second cryptographic method media key.

The inventive media brings along advantages in parallel with the advantages of the inventive method of writing decryption information to a storage medium. In other words, the inventive storage medium is compatible with two cryptographic methods. Data can be retrieved from the storage medium using either solely the first cryptographic method (by evaluating the first cryptographic method encrypted version of the data content key) or using the second cryptographic method for the key retrieval procedure and applying the first cryptographic method only for the final decryption of the encrypted data content using the first cryptographic method data content key.

In another preferred embodiment, the storage medium comprises information from which the first cryptographic method media key can be derived, and information from which the second cryptographic method media key can be derived. Thus, depending on which approach (first cryptographic method or second cryptographic method) a media player device is using for accessing the data content of the storage medium, an appropriate media key for the respective cryptographic method of choice can be obtained.

In another preferred embodiment, the medium comprises the information for obtaining the media keys in a prewritten or stamped form, i.e. as a read-only or non-user-writable information. This avoids that a user may undesirably (or illegally) modify the information for obtaining a media key, which may constitute a potential risk for a hacker attack.

Further contents of the amended storage medium are such as described with respect to the inventive method of writing decryption information and bring along the above-described advantages.

The present invention further comprises a method for reading data from a storage medium for storing an encrypted data content, the encrypted data content being adapted, using a data content key, for decrypting the encrypted data using a first encryption method. The storage medium further comprises a first cryptographic method encrypted data content key and a second cryptographic method encrypted data content key or a second cryptographic method encrypted and first cryptographic method encrypted data content key.

The inventive method of reading data from a storage medium comprises checking, whether the storage medium is recorded using a first recording method or using a second recording method. If the storage medium is recorded using the first recording method, the data content key is recovered using a second encryption method media key. Further, the encrypted data content is decrypted using the first cryptographic method and the data content key.

In other words, the inventive method provides an improved copy protection by ensuring that the data content key is recovered using the second cryptographic method media key if the medium is recorded using a first recording method. Thus, for a first recording method, which may be a home user recording method, for example, the inventive method of reading data from the storage media automatically enforces that the second encryption method media key is used for the decryption of the encrypted data content on the storage medium. In contrast, if the storage medium is recorded using another recording method (e.g. an industrial manufacturing recording method) different methods of accessing or decrypting the data content are allowed by the inventive method.

The inventive method of reading data from the storage medium brings along the advantage that cryptographically strong authentication (according to the method for obtaining the second cryptographic method media key) is enforced, if it is detected that the medium is recorded using the first recording method. This is advantageous as for some recording methods (e.g. home user recording) only the usage of a cryptographically strong content protection system (e.g. second cryptographic method) should be allowed. In contrast, media produced using another second recording method are requested to bring along such strong cryptographic authorization requirements. In contrast, when the storage medium is recorded using the second recording method (e.g. industrially manufactured by stamping) the manufacturer of the medium is responsible for applying an appropriate content protection system.

Thus, for the first recording method, a strict enforcement of the usage of the second cryptographic method brings along a high degree of security against unauthorized use of the content (e.g. by home users), while a storage medium recorded using the second recording method can be read even if only a (typically weaker) first cryptographic method has been applied.

The latter option maintains the possibility to read the data from a conventional, old storage medium (e.g. a conventional stamped DVD) if it is recorded using the second recording method. This mechanism provides a maximum backward compatibility of the method of reading with old media.

The described inventive method of reading data from a storage medium is particularly advantageous if the first method is the CSS content scrambling system and the second method is the VCPS content protection method, and if the first recording method is a method of recording to a writeable medium, while the second recording method is a method of producing a read-only medium.

This is due to the fact that it is undesirable to accept the production of CSS protected media by writing to a writeable medium. In other words, it should be excluded that, when reading data from a medium, a medium is accepted if it is written by a home user and does not contain cryptographically strong VCPS content protection. The described method of reading data from a storage medium therefore makes it useless for home users to make an attempt to (illegally, trying to circumvent copyrights) produce a CSS protected medium without additional VCPS protection. According to the inventive method of reading data from a storage medium, such a medium, being produced by a home user and not containing VCPS content protection information, would not be successfully read.

In contrast, the described restriction to reading VCPS protected media only should not apply if the storage medium is an industrially fabricated (e.g. stamped) storage medium, as a large number of conventional media merely containing CSS content protection information is legally available, and as the content of these conventionally available and legally acquired media should remain available to the respective owners thereof.

In a preferred embodiment, the method of reading data from a storage medium further comprises checking whether the storage medium comprises key information for use with the second encryption medium, and, if so, blocking access to a first encryption method key information, which is not encrypted using the second encryption method. Such a concept is particularly advantageous as, according to the present invention, the storage medium may include both information for access to data content using a first cryptographic method and for access to the data content using a second cryptographic method. However, it was found that the first cryptographic method (e.g. CSS) can easily be attacked. From the key information of the first cryptographic method, the data content key can be obtained illegally. In order to prevent such illegal access, novel media player devices or media readers applying the inventive method of reading data from a storage medium simply do not grant access to the (cryptographically insecure) key information of the first cryptographic method, if a stronger content protection according to the second cryptographic method is found on the storage medium. Thus, a media player device or a media reader using the inventive method of reading data from a storage medium makes it much more difficult for a hacker to circumvent content protection mechanisms present on that medium, even if the medium by itself contains cryptographically weak first cryptographic method key information.

Thus, a hacker would only be able to access the cryptographically weak first cryptographic method key information using old media reader devices, but would not be able to take profit of technological advantages provided by new and inventive media reader devices implementing the described method when making an attempt to break content protection. Thus, content protection is not only provided by the medium but also by the media player device blocking access to cryptographically weak information.

In another preferred embodiment, the method of reading data from a storage medium comprises checking whether a valid water mark out of a set of at least one water mark is present on the storage medium, and restricting access to data content on the storage medium, if a valid water mark is not present on the storage medium and a second encryption method information is present on the storage medium. In other words, full access to the data content of a storage medium protected using the second cryptographic method is only granted if additionally a valid water mark is present on the medium.

So, the presence of information for the second cryptographic method may be reused for indicating whether the presence of a water mark should be validated for granting or restricting access to the data content stored on the storage medium. In this way it can be reached that additional information carried in the water mark may be evaluated in the context of the content protection using the VCPS content protection method.

For example, the information in the water mark may indicate whether, and if, under which circumstances and limitations, it is allowed to make a copy of the storage medium. Besides, the water mark may encode information on the owner of the storage medium or data contained thereon. Thus, access restrictions regarding the digital content on the storage medium can be defined precisely by a combination of a water mark and the second cryptographic encryption method. Besides, possible offenders of the copyrights can possibly be identified by means of the water mark.

The concept of watermarking may also be used in order to cryptographically bind the content against the VCPS media. A watermark cryptographically binding the content against the VCPS media is an important feature, as it allows players to check for the watermark and thus see if it matches the VCPS unique key of the media on which the content resides. So, even if a pirate manages to hack the encryption, the watermark will still prevent playback if the content does not reside on the original VCPS media.

Thus, the described watermarking may increase security when compared to a forensic watermarking.

In other words, in a preferred embodiment the inventive method checks whether the information encoded in the watermark of the data content is identical to a characteristic information of the media, e.g. any key-related information on the medium, a VCPS root key, a VCPS unique identifier, a VCPS disc key, a VCPS unique key or another key information derived from the VCPS disc key

The inventive method also comprises a storage medium reader, which executes the steps described with respect to the inventive method of reading data from a storage medium. Therefore, the storage medium reader brings along the same advantage as the inventive method.

Furthermore, the invention comprises computer programs for implementing the inventive methods, as well as respective storage media comprising programs defining the inventive methods.

### BRIEF DESCRIPTION OF THE DRAWINGS

Preferred embodiments of the present invention will subsequently be described with reference to the enclosed figures, in which:

FIG. 1 shows a flow chart of the inventive method for writing decryption information to a storage medium, according to a first embodiment of the present invention;

FIG. 2 shows a flow chart of the inventive method for writing decryption information to a storage medium, according to a second embodiment of the present invention;

FIG. 3 shows a graphical representation of the content of an inventive storage medium according to a third embodiment of the present invention;

FIG. 4a shows a graphical representation of a sector of an inventive storage medium;

FIG. 4b shows a graphical representation of a content of a file system of an inventive storage medium;

FIG. 4c shows a graphical representation of a data structure of an inventive storage medium;

FIG. 5 shows a flow chart of a reference method for obtaining a data content from a CSS protected medium;

FIG. 6 shows a flow chart of an inventive method for obtaining a data content from a CSF+BCPS protected storage medium according to a 4^{th} embodiment of the present invention;

FIG. 7 shows a flow chart of an inventive method for obtaining data from a storage medium, according to a 5^{th} embodiment of the present invention; and

FIG. 8 shows a schematic diagram of a key hierarchy for the VCPS content protection system, according to the prior art.

### DESCRIPTION OF PREFERRED EMBODIMENTS

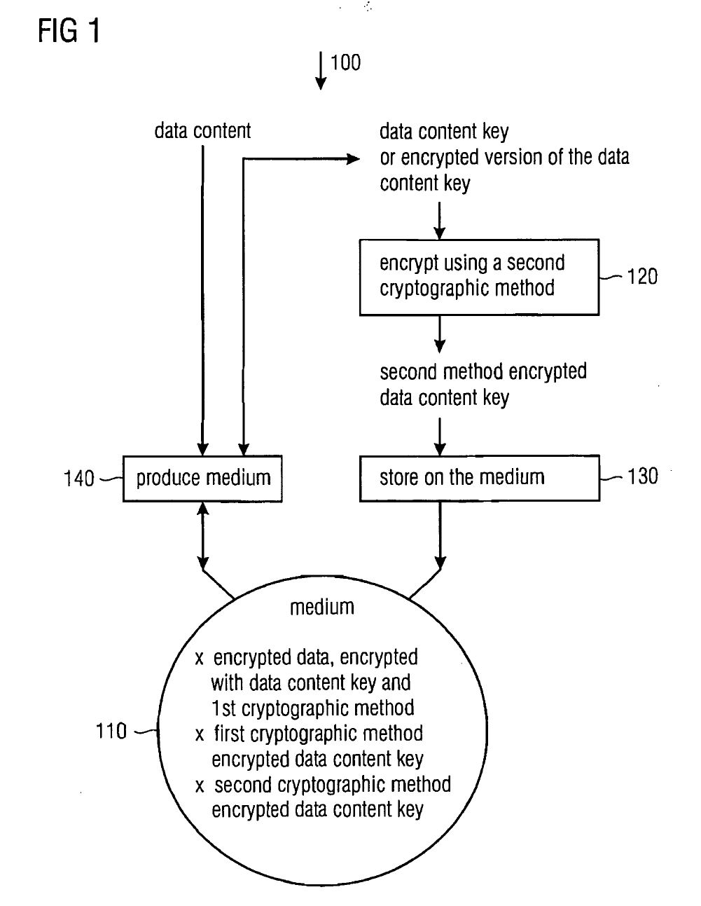

FIG. 1 shows a flow chart of the inventive method for writing decryption information to a storage medium, according to a first embodiment of the present invention. The method of FIG. 1 is designated in its entirety with 100. It is the core of the method 100 to produce a medium 110 such that the medium includes encrypted data, encrypted with a data content key using a first cryptographic method. The method 100 is further operative to produce the medium such that the medium includes a data content key encrypted using the first cryptographic method, which is also referred to as “first cryptographic method encrypted data content key” or “first method encrypted data content key”. Furthermore, the method 100 is adapted to produce the medium such that the medium contains the data content key encrypted using a second cryptographic method, wherein the respective encrypted version of the data content key is also referred to as “second cryptographic method encrypted data content key” or “second method encrypted data content key”. In order to achieve that the storage medium 110 comprises the described information, the method 100 receives a data content key, or an encrypted version of the data key, encrypted using a first cryptographic method (i.e. the “first cryptographic method encrypted data content key”).

In a step 120, the data content key or the encrypted version of the data content key (first cryptographic method encrypted data content key) is encrypted using the second cryptographic method. Thus, step 120 produces either a data content key encrypted using the second cryptographic method only (designated as “second method encrypted data content key” or “second-method-only encrypted data content key”), if the plain text data content key is encrypted in step 120, or a version of the data content key encrypted using the second cryptographic method and the first cryptographic method. In order to facilitate the understanding, the data content key encrypted using the second cryptographic method and the first cryptographic method is also designated here as “second method encrypted data content key”.

In step 130, the second method encrypted data content key is stored on the medium 110. Furthermore, an appropriate method step 140 for producing the medium ensures that the medium 110 comprises the information described above.

For producing the medium, several approaches are possible. For example, the medium may not yet comprise any data content or data content keys when entering the inventive method. In this case, producing the medium 110 comprises providing a data content key and encrypting the data content using the data content key in combination with the first cryptographic method. Further, producing the medium comprises providing the data content key or an encrypted version of the data content key to the step 120 to obtain the second method encrypted data content key, as described above. Also, producing the medium comprises writing to the medium 110 the first method encrypted data content key. Further, the second method encrypted data content key is stored on the medium 110 in step 130.

However, the inventive method is also operational to add the second method encrypted data content key to a medium which already contains encrypted data, encrypted with the data content key using the first cryptographic method, and the first cryptographic method encrypted data content key. In this case, producing the medium comprises obtaining from the medium the data content key or the first cryptographic method encrypted data content key as an input for step 120. Thus, in step 120 the second method encrypted data content key is produced. Subsequently, the second method encrypted data content key is stored on the medium 110 in step 130.

In other words, depending on which content the medium 110 comprises when entering the inventive method, the inventive method can be part of a procedure writing an encrypted data content to the medium 110 along with the first cryptographic method encrypted data content key and the second cryptographic method encrypted data content key, or can be part of a procedure for adding the second cryptographic method encrypted data content key to a medium already comprising the encrypted data content and the first cryptographic method encrypted data content key.

In other words, the inventive concept is to produce a medium, which, after the execution of the inventive method, comprises the above-described information.

In accordance with the method 100, a medium 110 is produced which contains the data content key in two different encrypted versions. Thus, the data content key can either be accessed making use of the first cryptographic method, or making use of the second cryptographic method. This allows the production of a medium 110, which is compatible with two different content protection systems, which may possibly have different cryptographic strength. For example, the first cryptographic method may be a cryptographic method which is no longer reliable, but which was already broken by a hacker's attack. On the other hand, the second cryptographic method may be a cryptographic method, which is cryptographically more secure and which is so far unbroken.

The medium 110 produced according to the inventive method is therefore compatible with media player devices which are adapted to apply algorithms belonging to the first cryptographic method, but which are not capable of performing algorithms belonging to the second cryptographic method. On the other hand, media player devices which are capable of applying algorithms of the second cryptographic method may access the data content key using the second cryptographic method, and may further be adapted in order to deny access to the cryptographically weak first cryptographic method encrypted data content key.

However, the data is still encrypted using the first cryptographic method. For cryptographic security this is not a serious problem though, provided the weak point of the first cryptographic method is an insufficient protection of the data content key, not an insufficient algorithm for encrypting the encrypted data.

In the following, detailed examples for an implementation of the inventive method 100 of FIG. 1 will be described, wherein it will be assumed that the first cryptographic method is the content scrambling system (CSS) method, and that the second cryptographic method is the video content protection system (VCPS) method.

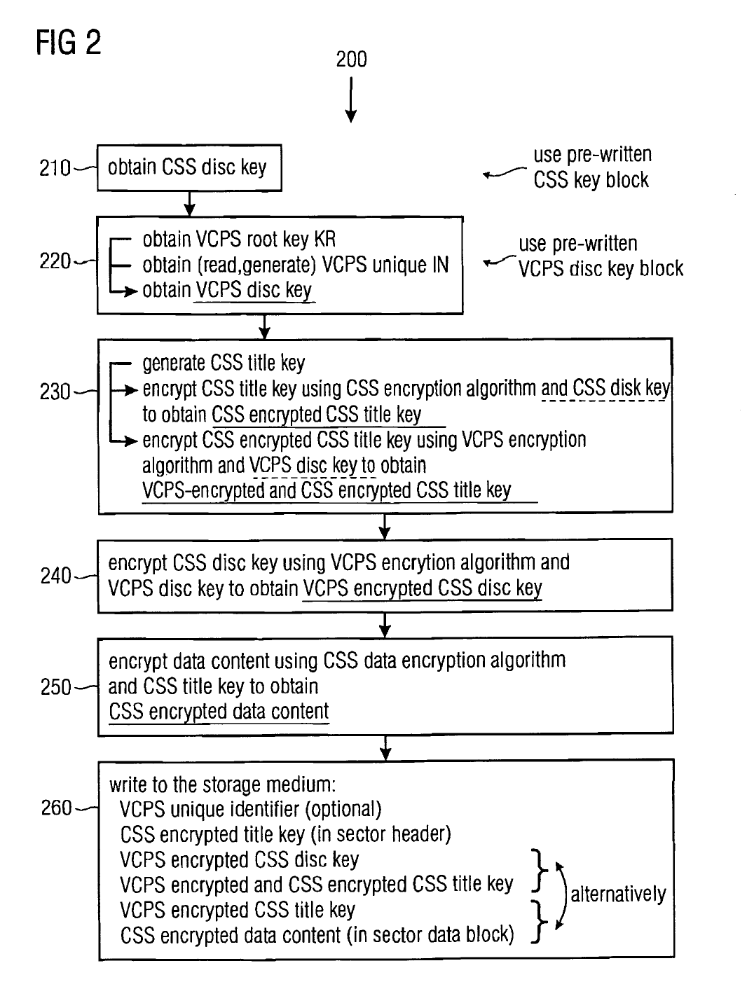

Thus, FIG. 2 shows a flow chart of an inventive method for writing decryption information to a storage medium, according to a second embodiment of the present invention. The method of FIG. 2 is designated in its entirety with 200.

In a first step 210, a CSS disc key is obtained from the medium. Obtaining the CSS disc key may require obtaining a specific information from the storage medium (e.g. a DVD) and applying to the specific information a secret (e.g. a secret key).

I a second step 220, a VCPS root key KR is obtained. For this purpose, a VCPS specific information is read from the storage medium (e.g. DVD), and a secret is applied to the VCPS specific information. Furthermore, in step 220 a VCPS unique ID is obtained. Obtaining the VCPS unique ID comprises reading the unique ID from the storage medium, if the storage medium already contains the unique ID. However, a new storage medium typically does not contain a unique ID. In this case, the unique ID is generated by a random number generator and stored on the storage medium. Furthermore, step 220 comprises obtaining a VCPS disc key by combining the VCPS unique ID and the root key KR, as outlined in the VCPS specification.

In a third step 230, the CSS title key (or a CSS sector key) is generated for a sector of data to be written to the storage medium. The CSS title key (or CSS sector key) is further encrypted using an appropriate CSS encryption algorithm and the CSS disc key, to obtain a CSS-encrypted CSS title key (or CSS sector key). Details with respect to the encryption are described in a number of articles available on the Internet.

It should be noted here, that for the further procedure, either a CSS sector key or a CSS title key may be used. Thus, any reference to the CSS title key also, alternatively, refers to a CSS sector key. In other words, the inventive method may also be applied to CSS sector keys.

Step 230 further comprises encrypting the CSS-encrypted CSS title key using an appropriate VCPS encryption algorithm (e.g. an AES encryption algorithm) and the VCPS disc key. From the encryption of the CSS-encrypted CSS title key, a VCPS-encrypted and CSS-encrypted CSS title key is obtained. In other words, a representation of the CSS title key encrypted both with an algorithm of the CSS cryptographic method and, subsequently, an algorithm of the VCPS cryptographic method is obtained.

In a fourth step 240, the CSS disc key is encrypted using a VCPS encryption algorithm (e.g. an AES encryption algorithm) and the VCPS disc key. Thus, a VCPS-encrypted CSS disc key, which is a VCPS-encrypted representation of the CSS disc key, is obtained.

In a fifth step 250, data content (e.g. a sector of an audio-video stream) is encrypted using a CSS data encryption algorithm and the CSS title key. Thus, CSS encrypted data content is obtained.

In a sixth step 260, the relevant information is written to the storage medium. If the storage medium does not yet contain a VCPS unique identifier, the VCPS unique identifier is written to the storage medium. Further, the CSS encrypted title key is written to the storage medium, for example in a sector header of an associated sector, so that the CSS encrypted title key is usable for the decryption of the encrypted data content of the sector in whose sector header the CSS encrypted title key is contained.

Furthermore, the VCPS encrypted CSS disc key is written to the storage medium, as well as the VCPS encrypted and CSS encrypted CSS title key. Also, CSS encrypted data content is written to the storage medium, for example in a data block of a sector.

In an alternative embodiment, the encryption of the CSS encrypted title using the VCPS encryption algorithm and the VCPS disc key can be omitted. Also, the encryption of the VCPS disc key using the VCPS encryption algorithm and the VCPS disc key can optionally be omitted. However, if the VCPS encrypted and CSS encrypted CSS title key is not generated, a VCPS encrypted CSS title key (or a VCPS-only encrypted CSS title key) has to be generated using the plain text CSS title key and the VCPS disc key. In this case, it is sufficient to store to the medium the VCPS encrypted CSS title key, as a replacement for the VCPS encrypted CSS disc key and the VCPS encrypted and CSS encrypted CSS title key. This is due to the fact that using the VCPS encrypted CSS title key, the CSS title key can directly be obtained using an algorithm of the VCPS cryptographic method.

In other words, a system capable of writing VCPS+CSS protected discs using the inventive method 200 first obtains/generates the relevant CSS disc and title keys used for encrypting the content that is to be recorded using those keys. The CSS disc key and the VCPS keys are pre-written to a VCPS+CSS medium at manufacturing time. In other words, a medium usable by the method 200 comprises a pre-written information from which a CSS disc key can be derived using a CSS procedure and a certain secret, and another information from which the VCPS disc key can be derived using a VCPS procedure, a VCPS unique identifier and a VCPS secret.

The CSS title key is not pre-written (i.e., not stamped or embossed) to the VCPS+CSS medium, but the CSS title key is written to the medium during a recording. Such a procedure is necessary because CSS title keys are stored in the sector headers of sectors they encrypt. A sector header typically cannot be written without writing the payload of such a sector. Therefore, CSS title keys cannot be pre-written to a VCPS+CSS medium at manufacturing time.

It should be noted here that the inventive method 200 can be executed both in a stand alone media recording device and in a PC-based media recording device. For the communication between the personal computer and the media recorder (e.g. a DVD recorder) an authentication between the personal computer mainframe or software and the DVD recorder must be successfully completed. In other words, a host computer or a software running on the host computer (PC) must authenticate to a storage medium writer (e.g. a DVD writer) in order to obtain the VCPS disc key. The VCPS disc key is composed of a unique ID created by the recorder firmware when the disc is initially used. In other words, when a VCPS enabled disc is used for the first time for encrypted recording, the firmware of the DVD recorder generates and writes to the disc (e.g. in encrypted form or in plaintext form) an unique ID. Thus, as soon as a software successfully authenticates with the DVD recorder, the DVD recorder either transfers to the software the unique ID created by the recorder, or reads out the unique ID from the DVD. A VCPS disc key is also composed of a root key created from information stored on the disc (storage medium) as well as information known only to an authorized recording software communicating with the DVD recorder. Upon obtaining the required information form the DVD recorder, the VCPS disc key is calculated from all its components by applying the instructions detailed in the VCPS specification.

Thus, any confidential information involved in the method 200 is transported in an encrypted way between a DVD recorder and a host PC or a software. Consequently, eavesdropping is prevented.

Besides, the data content stored to the VCPS media may optionally comprise a watermark. The watermark encodes or represents a unique key information used in the process of encrypting the data content. The unique key information is preferably an information bound to the medium, e.g. a VCPS unique key, a VCPS disc key or a cryptographic information derivable therefrom. The unique key may for example alternatively be a VCPS root key, a VCPS program key or a VCPS sector key. Besides, the unique key may be a CSS root key, a CSS disc key or a CSS title key.

In this case, the inventive method of writing decryption information to the storage medium further comprises the step of adding the watermark to the data content, the information of the watermark representing the unique key information as defined above. In other words, the watermark represents an information which is unique for the media used in the method of writing.

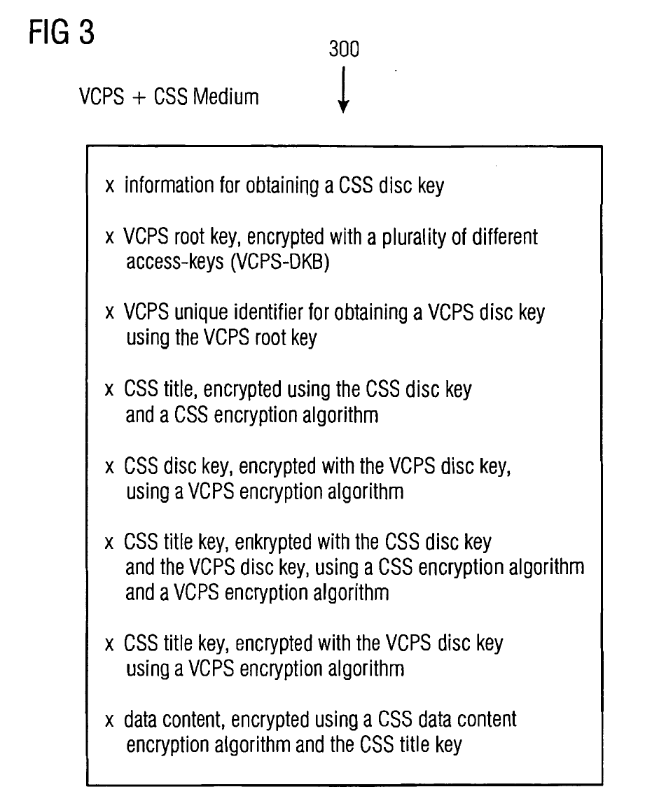

In the following, the data content of an inventive storage medium (e.g. a DVD) will be outlined. For this purpose, FIG. 3 shows a graphical representation of the content of an inventive storage medium according to a third embodiment of the present invention. The storage medium is designated in its entirety with 300, and is also referred to as a “VCPS+CSS protected disc”.

The storage medium 300 comprises an information for obtaining a CSS disc key, which is typically, at least partly, applied to the disc by a disc manufacturer. In other words, at least a part of the information for obtaining the CSS disc key is stamped, embossed or prewritten to the storage medium 300 at manufacturing time. The structure of the CSS medium can for example be taken from the specification of the CSS content scrambling system. Additional information with respect to the CSS content scrambling system is also available on the Internet.

The storage medium 300 further comprises the VCPS root key, encrypted with a plurality of different access keys. The described information, which constitutes the VCPS disc key block, is also typically provided on the storage medium by the manufacturer of the medium in a read-only region of the storage medium 300. However, under some circumstances a copy of the VCPS disc key block may also be stored in a writeable region of the storage medium.

The storage medium 300 further comprises a VCPS unique identifier, as outlined in the specification of VCPS referenced above. The VCPS unique identifier is written to a writeable region of the storage medium when the disc is initially used, and defines, together with the information of the VCPS disc key block, the VCPS disc key.

The above-described information can be used in order to obtain both the CSS disc key (CSS media key) and the VCPS disc key (media key). It should be noted here that using the information described so far, the CSS disc key and the VCPS disc key can be obtained independently of each other.

Furthermore, the storage medium 300 comprises a data content (e.g. audio-video data or any other cryptographically protected data), which are encrypted using a CSS data content encryption algorithm and the CSS title key (or a plurality of respective CSS title keys and/or CSS sector keys). In other words, the data content is encrypted such that it can be decrypted using the CSS title key (or CSS title keys or CSS sector keys). For this reason, the storage medium 300 further comprises additional information which can be used in order to obtain the relevant CSS title key.

Thus, the storage medium 300 comprises the CSS title key encrypted using the CSS disc key and the CSS encryption algorithm. The CSS title key is valid for encrypting a sector of the data content stored on the storage medium 300. Also, the CSS title key for the respective sector is stored in the sector header.

The storage medium 300 further comprises the CSS title key, encrypted both with the CSS disc key and the VCPS disc key, using both (in a sequence) a CSS encryption algorithm and a VCPS encryption algorithm. Thus, for decrypting the two times encrypted CSS title key, it is necessary to know (or to have access to) both the CSS disc key and the VCPS disc key.

In order to avoid the necessity to access the pre-written information for obtaining the CSS disc key, the CSS disc key is further included on the storage medium 300 encrypted with the VCPS disc key, using a VCPS encryption algorithm. It should be noted that the CSS disc key, encrypted with the VCPS disc key, and the CSS title key, encrypted with the CSS disc key and the VCPS disc key, are preferably both stored in two separate files accessible in a file system of the storage medium 300.

However, alternatively the storage medium 300 may comprise the CSS title key, encrypted with the VCPS disc key using a VCPS algorithm, so that the CSS title key can be obtained from the VCPS encrypted version thereof without applying the CSS disc key. In other words, the CSS title key, encrypted (only) with the VCPS disc key using a VCPS encryption algorithm may replace the CSS disc key, encrypted with the VCPS disc key, and the CSS title key, encrypted with both the CSS disc key and the VCPS disc key.

However, in another embodiment all three information, i.e. the CSS disc key, encrypted with the VCPS disc key, the CSS title key, encrypted with the CSS disc key and the VCPS disc key, and the CSS title key, encrypted with the VCPS disc key only, may be contained on the storage medium 300.

It should be noted here that in the above discussion and also in the following explanations, the terms “CSS title key, encrypted with the CSS disc key and the VCPS disc key” and “CSS title key, encrypted with the VCPS disc key” describe two different encrypted versions of the CSS title key. In other words, only when it is explicitly mentioned that the value is encrypted using a certain key, the encryption is actually present. In other words, the expression “CSS title key, encrypted with the VCPS disc key” means that an encryption using any other key is not performed, except it is explicitly written. In other words, “CSS title key, encrypted with the VCPS disc key” means “CSS title key, encrypted with the VCPS disc key, but not with the CSS disc key” or, equivalently “CSS title key, encrypted only with the VCPS disc key”. Thus, from the CSS title key, encrypted with the VCPS disc key, the plain text CSS title key can be obtained using a VCPS disc decryption algorithm provided the VCPS disc key is known. On the other hand, the plain text CSS title key can only be obtained from the CSS title key, encrypted with the CSS disc key and VCPS disc key, if both the CSS disc key and the VCPS disc key are known, and both the CSS decryption algorithm and the VCPS decryption algorithm are applied.

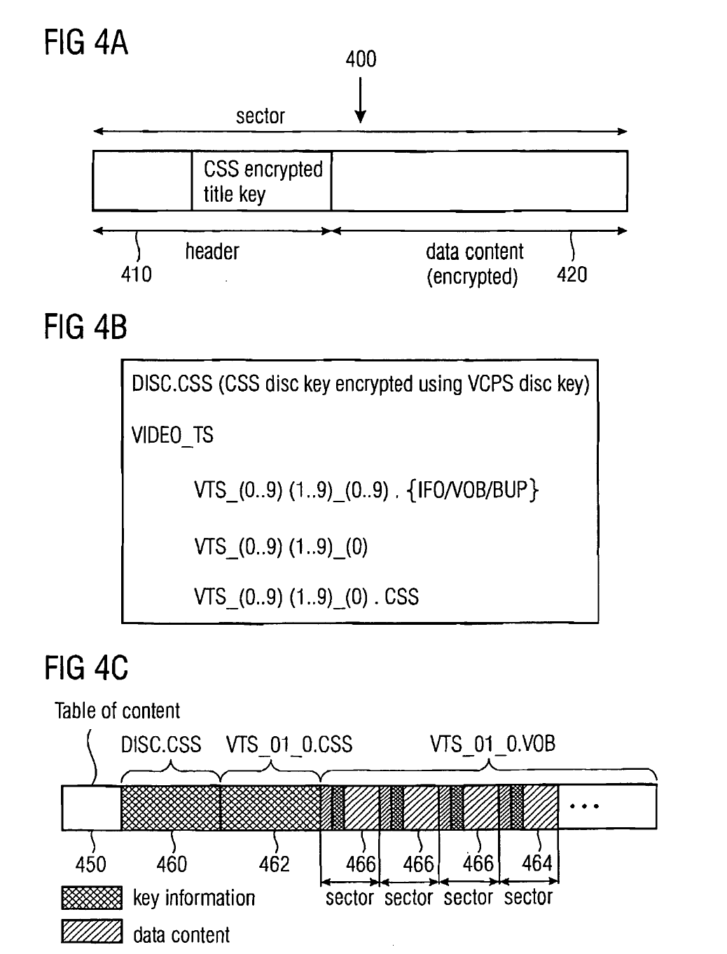

In the following, a structure in which the above-described information is contained on the storage medium 300, will be described in more detail. For this purpose, FIG. 4A shows a graphical representation of a sector of an inventive storage medium. A sector typically consists of a number of contiguously stored data bits or data samples. For example, a sector may contain 2048 or 2056 bytes. A sector is logically divided into a sector header containing meta-information regarding the data content stored in the sector.

In FIG. 4A, the sector is designated in its entirety with 400. A sector header, which comprises a number of bits or bytes typically arranged at a logical beginning of the sector 400 is designated with 410. The rest of the sector contains an encrypted data content and is designated with 420. In other words, a header comprising the CSS-only encrypted title keys is combined in a sector with the data content, which is encrypted using a data content encryption algorithm of the CSS cryptographic method and the respective CSS-only encrypted key.

It should further be noted, that an encrypted video title set comprises a plurality of sectors 400, wherein typically a plurality of sectors is physically arranged on the storage medium in a contiguous sequence without any additional information (except for some synchronization patterns) in between the sectors. So, an encrypted title set comprises a plurality of sectors arranged such that a media reader alternately reads out sector headers and encrypted data content. Thus, the encrypted data content and the respective CSS-only encrypted title keys are physically located in adjacent regions, i.e. in adjacent parts of sectors, to form a contiguous block of key data and content data according to the physical structure of the storage medium.

On the other hand, additional key information is stored in dedicated files of a file system of the storage medium. For a detailed explanation of the file system, reference is made to FIG. 4b, which shows a graphical representation of a data content of a file system of an inventive medium. For example, the inventive storage medium comprises a root directory (or main directory). The root directory comprises a link to a file named “DISC.CSS” and a subdirectory named “VIDEO_TS”. Thus, the main directory contains both a file name of the respective files (for example encoded in plain text using a predetermined character set) and a link indicating the actual position of the respective files (or subdirectories) on the medium. Thus, the main directory of the storage medium allows access to the described subdirectories without requiring that the operating system has an a-priori knowledge of the actual physical position of the files.

The subdirectory named for example “VIDEO_TS” comprises a first file having a file name of the form “VTS_{—}[0 . . . 9][1 . . . 9]_{—}[0 . . . 9].{IFO]|VOB|BUP}”, a second file named “VTS_{—}[0 . . . 9][1 . . . 9]_{—}[0]” and a third file named “VTS_{—}[0 . . . 9][1 . . . 9]_{—}[0].CSS”.

It should be noted that the file system indeed may consist of multiple files named according to the scheme “VTS_{—}[0 . . . 9][1 . . . 9]_{—}[0 . . . 9].{IFO|VOB|BUP}”, wherein “[ ]” indicates an optional element, wherein “0 . . . 9” is a range of numbers from 0 to 9, and wherein {IFO|VOB|BUP} indicates that one out of the options “IFO”, “VOB” and “BUP” is used, as known for a man skilled in the art from the syntax definition of various programming languages.

Thus, the inventive file system typically comprises one file name VTS_{—}[0 . . . 9][1 . . . 9]_{—}[0], stored in a folder (or subdirectory) called “VIDEO_TS”. In addition to legacy DVD video content, the inventive file system also contains one file VTS_{—}[0 . . . 9][1 . . . 9]_{—}[0].CSS per title set containing a CSS title key corresponding to the title set in encrypted form. The root directory (or main directory) of such a DVD video storage medium contains a file named “DISC.CSS” containing the encrypted (or VCPS-encrypted) disc key (or CSS disc key). All “VTS_{—}[0 . . . 9][1 . . . 9]_{—}[0].CSS” files and the DISC.CSS file are encrypted using the VCPS disc key.

In other words, the file DISC.CSS stored in the root directory of the DVD video storage medium contains a CSS disc key, encrypted using the VCPS disc key. The file “VTS_{—}[0 . . . 9][1 . . . 9]_{—}[0 . . . 9].{IFO|VOB|BUP}” contains the data content encrypted using one or more CSS data content keys, one CSS data content key for each encrypted sector. The respective data content file (VTS_{—}[0 . . . 9][1 . . . 9]_{—}[0.99].{IFO|VOB|BUP}) thus comprises a plurality of sectors wherein each encrypted sector comprises a CSS encrypted title key, but wherein some of the sectors may not be encrypted. Thus, the data content file comprises a combination of encrypted data and key information, placed on the storage medium in a physically alternating manner.

Further, a file with VCPS-encrypted CSS title keys is attributed to each encrypted data file, and the file with the VCPS encrypted CSS title keys is named “VTS_{—}[0 . . . 9][1 . . . 9]_{—}[0].CSS”. Thus, the described file comprising typically a plurality of VCPS-only encrypted CSS title keys or VCPS- and CSS-encrypted title keys includes the information required for decrypting multiple sectors of the corresponding encrypted data file.

In other words, the file “VTS_{—}[0 . . . 9][1 . . . 9]_{—}[0].CSS” contains a concentrated key information such that the key information is not interrupted by any encrypted data content, in contrast to the file with the encrypted data content and the CSS title keys.

FIG. 4c shows a graphical representation of a data structure on an inventive storage medium. The logical structure of the storage medium is represented in a linear form. The inventive storage medium contains a table of contents 450 located in a certain predetermined position of the storage medium. Furthermore, the storage medium comprises a contiguous file 460 named “DISC.CSS”. The file “DISC.CSS” contains as a data content key information, i.e. VCPS-encrypted CSS title keys. Another file 462 named for example “VTS_{—}01_{—}0.CSS”, which is also stored on the storage medium as a contiguous file, contains as a data content the VCPS-encrypted CSS title keys or the VCPS-encrypted and CSS-encrypted CSS title keys. The storage medium further comprises an encrypted data content file 464, named for example “VTS_{—}01_{—}0.VOB”. The encrypted data content file 464 comprises a data content of the storage medium (or a part of the data content, e.g. a title set of a DVD), encrypted using a CSS encryption algorithm and a CSS data content key. To be more specific, the encrypted data content file 464 comprises a plurality of sectors 466. At least some of the sectors 466 comprise encrypted data content, while other sectors 466 may optionally comprise a plain text, non encrypted data content. In the sector headers of the encrypted sectors 466, CSS data content key information is included, defining an encryption key for the encryption of the data content of the respective sector 466.

It should be noted that the file system described with reference to FIG. 4b may for example be of a “ISO9660+UDF” format according to a DVD specification. Also, the structure of the data on the inventive storage medium described with reference to FIG. 4c may fulfil the specification of the “ISO9660+UDF” format. In order to produce the storage medium 300, such that the storage medium comprises a data structure as described with reference to FIGS. 4a, 4b and 4c, requires to bring the information described with reference to FIG. 3 to a given format. In other words, the preparation of the content written to an inventive VCPS+CSS protected disc involves the creation of a file system in a “ISO9660+UDF” format according to a DVD video specification. A system, e.g., a DVD recording software running on a host PC in cooperation with a DVD writer device or a stand-alone DVD recorder prepares a content such that it consists of multiple sectors that can be produced sequentially, starting from the first sector and ending with the last sector that has to be written to the CSS+VCPS protected media. The process of preparing the content in such a way is performed by a so-called file system formatter. In other words, the system (DVD recording software or stand-alone DVD recorder) brings the file system described with reference to FIGS. 4a, 4b, 4c in a format which can be linearly written in the form of subsequent sectors, as is required for writing a DVD medium.

The sectors of the medium that belong to CSS encrypted title sets are consequently encrypted using the CSS block cipher algorithm, which is also designated as “CSS data content encryption algorithm”. All sectors that belong to a current recording are then written to the medium using the methods dedicated to this process by the recorder device. Typically, content is written using WRITE commands according to the MMC command set and are sent over a bus connecting the recorder device and the host personal computer. On or more sectors are written with each command sent to the DVD recorder in sequential order.

In the following, it will be described how the data content written to the DVD using the methods described above can be read out from the storage medium and can be decrypted.

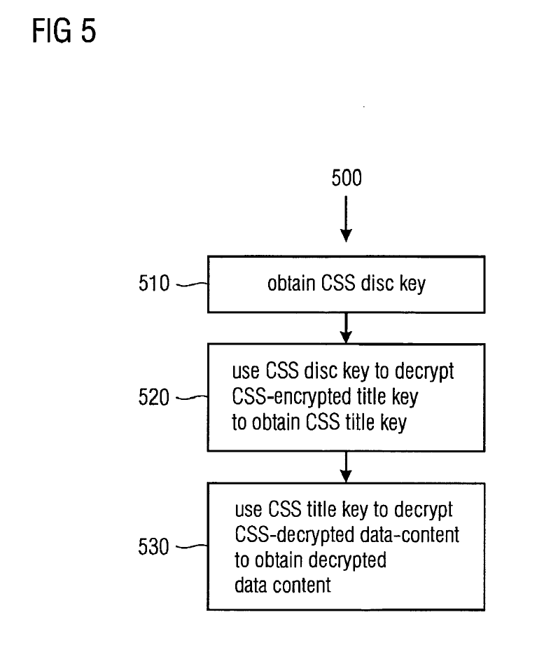

For the sake of explanation, FIG. 5 shows a flow chart of a reference method for obtaining data content from a CSS protected medium. The method of FIG. 5 is designated in its entity with 500. According to the method 500, it is necessary that the storage medium comprises a valid CSS content scrambling system copy protection information. To be more specific, it is assumed in the following that a CSS protected medium comprises an information for obtaining a CSS disc key, data content encrypted using a CSS data content encryption algorithm and the CSS title key, and the CSS title key, encrypted using the CSS disc key and a CSS encryption algorithm.

According to the method 500, the CSS disc key is first obtained in a decrypted form. For this purpose, information for obtaining the CSS disc key, which is contained on the CSS protected storage medium, is evaluated. Further, a secret which is (in principle) only known to an authorized DVD media player device or a DVD player software is applied. In other words, the CSS disc key is obtained in a first step 510, as defined by the specification of the CSS content scrambling system. In a second step 520, the CSS disc key is used to decrypt a CSS encrypted title key to obtain a plain text CSS title key. For this purpose, the CSS-encrypted CSS title key is read from the CSS protected storage medium, and a CSS key decryption algorithm is applied to the CSS encrypted title key. As soon as the plain text version of the CSS title key is obtained, the plain text CSS title key is used in a third step 530 to decrypt the CSS-encrypted data content. From the decryption, a decrypted data content, i.e. a plain text data content, is obtained.

It should further be noted that a CSS data decryption algorithm, e.g. a CSS cipher-block-chain (CBC) decryption algorithm, is applied for obtaining the plain text data content. Further, the CSS title key may be combined with CSS sector keys in order to obtain data content keys for the individual sectors of the decrypted data content.

To summarize the above, it can be stated that the method 500 is based on obtaining the CSS disc key using a secret. Once the secret is known for obtaining the CSS disc, the decrypted data content can be read out from the storage media. Further, the method 500 is cryptographically weak, as a secret required for obtaining the CSS disc key has been broken. Therefore, hackers are able to obtain the CSS disc key and the CSS title key, although they are not authorized. Therefore the method 500 does not provide sufficient security to efficiently prevent unauthorized access to the CSS encrypted data content.

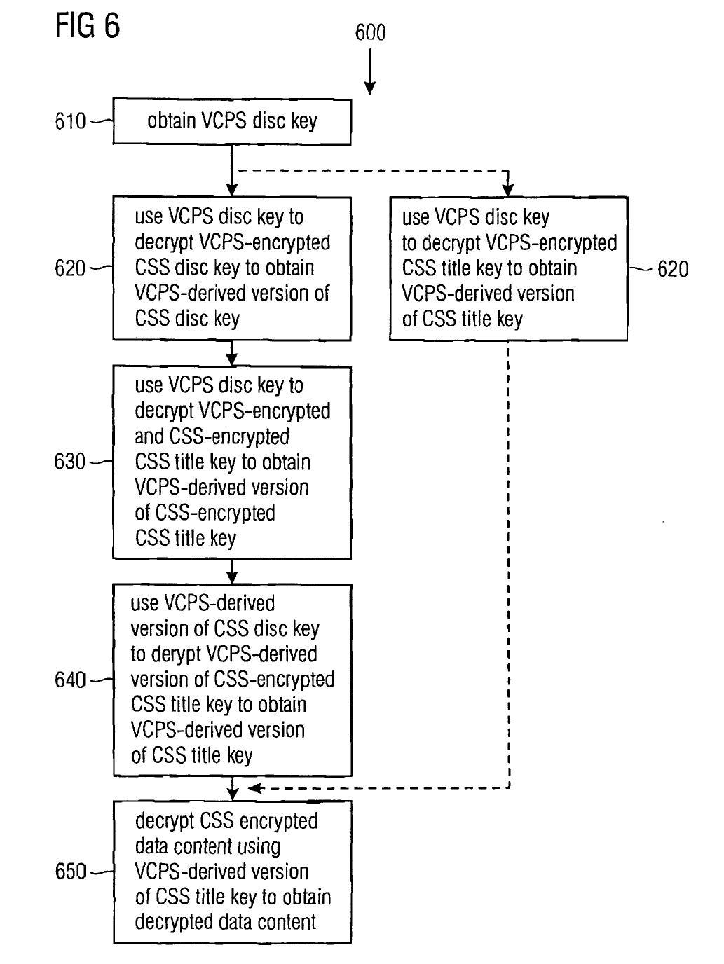

In order to improve this situation, a new algorithm for accessing the encrypted information on the storage medium has been developed. FIG. 6 shows a flow chart of an inventive method for obtaining the data from a CSS+VCPS protected storage medium according to a fourth embodiment of the present invention. The method of FIG. 6 is designated in its entity with 600.

It is assumed that the storage medium contains information as described with reference to FIG. 3, wherein the medium may contain either a VCPS-encrypted CSS disc key and a VCPS-encrypted CSS title key, or a VCPS-encrypted (and not CSS encrypted) CSS title key. However, the medium may also comprise both information. Further, the medium may optionally comprise additional information for directly obtaining the CSS disc key without using the VCPS algorithm, e.g. a CSS disc key encrypted with a plurality of secret keys.

However, the dedicated CSS key information, i.e. information for directly obtaining the CSS disc key using a CSS disc key generation algorithm, is not required for executing the method 600, but merely serves to maintain backward compatibility with conventional playback devices, capable only of performing CSS authentication.

It should be noted here, that the inventive method 600 can be performed either by a stand-alone media reader device or by interaction of a host PC running a media player software and a PC DVD reader device (or combined reader/writer device). In other words, the steps of the method 600 can be distributed between hardware and software, wherein the communication between hardware and software is preferably done using a secure connection such that data is transported in an encrypted form. To be more specific, the communication between the host PC and the PC-DVD reader device is encrypted, possibly using a key exchange mechanism as outlined in the VCPS specification.

In a first step 610 of the inventive method 600, the VCPS disc key is obtained. For this purpose, the DVD reader device reads out a typically pre-written key information contained on the DVD medium, which may typically be a new CSS+VCPS medium. In other words, an encrypted version of a VCPS root key KR is read out from the DVD and combined with a secret contained either in the DVD reader hardware or in the DVD reader software (or DVD media playback software). Another information from the DVD, namely the VCPS unique ID, is applied to the VCPS root key in order to obtain the VCPS disc key. Further details with respect to this process are outlined in the specification of the VCPS content protection system.

It should be noted here that obtaining the VCPS disc key may optionally require an authentication between a DVD reader device and a DVD reader software, if a software based solution is used. For this purpose, a key exchange algorithm is executed, and a session key is established in order to allow for a secure communication between the DVD reader software and the DVD reader hardware. In other words, the communication over the interface between the host PC and the DVD reader hardware is encrypted using the session key.

It should be noted further that the step 610 of obtaining the VCPS disc key will typically fail, if either the DVD reader hardware or the DVD reader software are not authorized, as in this case either the DVD reader software or the DVD reader hardware does not contain the required secret. It should be noted here that the VCPS authentication algorithm is so far unbroken, so that it may be assumed that if a (valid) VCPS disc key is obtained, both the DVD reader hardware and the DVD reader software are in accordance with the copyright regulations.

It should further be noted that optionally a check may be executed after step 610, whether a valid VCPS disc key was obtained. If it is found that the VCPS disc key is not valid, the algorithm can be aborted. However, if no check is performed, an incorrect decryption of the encrypted data content will occur for the case that an invalid VCPS disc key was obtained in step 610, e.g. by an unauthorized media reader software.

In a second step 620, the (plain text) VCPS disc key obtained in the first step 610 is used to the decrypt the VCPS encrypted CSS disc key to obtain a VCPS-derived version of the CSS disc key. In other words, in step 620 a version of the CSS disc key is derived which does not rely on any CSS disc key information which is present on the storage medium according to the conventional CSS standard, like the versions of the CSS disc key encrypted with CSS manufacturer keys. Rather, the file named for example “DISC.CSS” is evaluated and decrypted using the (plain text) VCPS disc key. In other words, in step 620 the CSS disc key is obtained using only the VCPS cryptographic method and the decryption algorithms defined by the VCPS cryptographic method.

In a third step 630, the VCPS disc key obtained in the first step 610 is used to decrypt the VCPS-encrypted and CSS-encrypted CSS title key to obtain a VCPS-derived version of the CSS-encrypted CSS title key. In other words, VCPS encryption is removed from the VCPS-encrypted and CSS-encrypted CSS title key, which can be obtained according to the present invention from the CSS+VCPS storage medium. Consequently, the VCPS-derived version of the CSS-encrypted title key is obtained by merely applying key retrieval and decryption algorithms defined by the VCPS cryptographic method.

In a fourth step 640, the VCPS derived-version of the CSS disc key determined in the second step 620 is used to decrypt the VCPS-derived version of the CSS encrypted CSS title key determined in the third step 630. In other words, a decryption algorithm as defined by the CSS cryptographic method is applied to the VCPS-derived version of the CSS-encrypted CSS title key, wherein the VCPS-derived version of the CSS disc key is used as the decryption key. By performing the described steps, a VCPS-derived (plain text) version of the CSS title key is obtained in the fourth step 640.

The VCPS-derived version of the CSS title key is used in a fifth step 650 in order to decrypt the CSS encrypted data content. For this purpose, a data decryption algorithm of the CSS cryptographic method, e.g. a CSS cipher-block-chaining (CBC) decryption algorithm is applied. As a consequence, the decrypted data is obtained in the fifth step 650.

In other words, the inventive algorithm 600 does no longer rely on the mechanism of the CSS cryptographic method for obtaining the CSS disc key, which was found to be a major security risk of the CSS cryptographic method. Rather, according to the inventive algorithm 600, the respective keys can only be decrypted if a VCPS disc key is obtained successfully, which still constitutes an unbroken hurdle to any unauthorized users.

It should further be noted here, that the VCPS- and CSS-encrypted CSS title key processed in the third step 630 may for example be obtained from a file on the storage medium named “VTS_{—}[0 . . . 9][1 . . . 9]_{—}[0 . . . 9].CSS”, which corresponds to a file named “VTS_{—}[0 . . . 9][1 . . . 9]_{—}[0 . . . 9].{ISO/VOB/BUP}” containing the encrypted data content.

However, there is an alternative way of obtaining a VCPS-derived version of the CSS title key. The second step 620, the third step 630 and the fourth step 640 can be replaced by an alternative step 660, provided the storage medium comprises a VCPS-encrypted version of the CSS title key, which is not additionally encrypted using a CSS encryption algorithm (i.e. a VCPS-only encrypted version of the CSS title key). In this case, the VCPS disc key obtained in the first step 610 can be used to decrypt the VCPS-encrypted CSS title key in the alternative step 660. Consequently, the VCPS-derived version of the CSS title key is obtained, comprising the CSS title key in plain text without the need for any further decryption. Thus, the VCPS-derived version of the CSS title key obtained in the alternative step 660 can be directly used in the fifth step 650 to decrypt the CSS-encrypted data content.

Thus, the second, third and fourth step 620, 630, 640 define as a “cascaded” solution in which an “intermediate” key is obtained making use of the VCPS disc key (namely the VCPS-derived version of the CSS disc key) to determine the VCPS-derived version of the CSS encrypted CSS title key. In contrast, the alternative solution of the alternative step 620 constitutes a single step solution. However, both solutions have in common that all the required keys are protected using the VCPS disc key, and may therefore be considered more secure than any of the keys merely protected by a CSS encryption algorithm. In other words, it is the key idea of the inventive concept to protect keys for the broken CSS cryptographic method by encrypting them using the significantly more advanced VCPS cryptographic method.

In the following it will be shown how an improved protection against unauthorized copying of a storage medium can be obtained, even if the medium comprises weakly protected CSS keys. It should be noted here, that indeed it is a key feature of the present invention to allow for such an improved security.

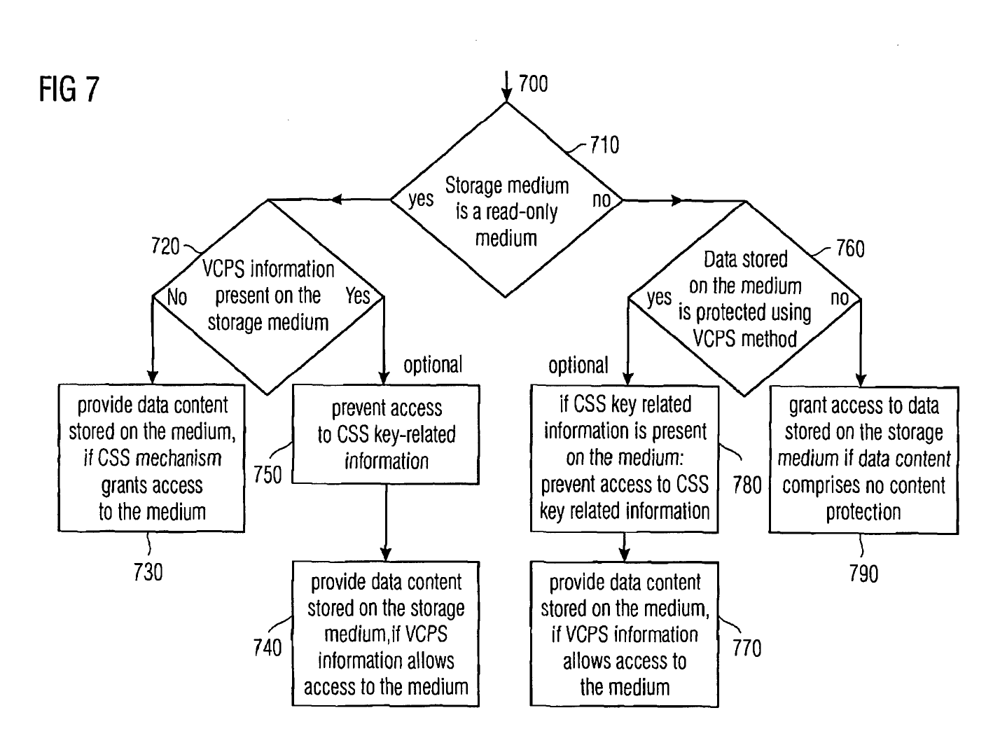

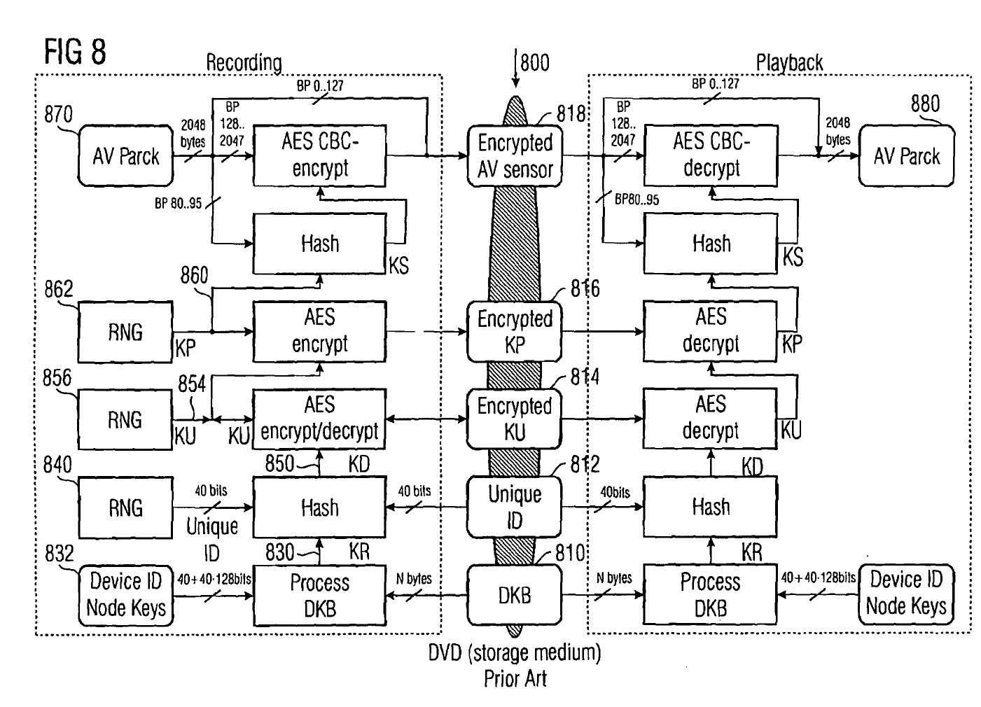

FIG. 7 shows a flow chart of an inventive method for obtaining data from a medium, according to a fifth embodiment of the present invention. The method of FIG. 7 is designated in its entity with 700.

In a first step 710, it is checked whether the storage medium is a read-only medium or not. This is important as according to the inventive concept it should not be allowable to have any CSS-only protected user writeable media. In contrast, it should be required that writeable media have either a VCPS content protection or no content protection at all (e.g. if they comprise no copyrighted content).

If it is found that the medium is a read-only medium in step 710, a second check is performed in a step 720 whether any VCPS related information is present on the storage medium. In step 720 it can for example be checked whether the storage medium comprises a VCPS disc key block, a VCPS unique identifier, a VCPS-encrypted CSS disc key, a VCPS-encrypted CSS title key, a VCPS-encrypted and CSS-encrypted CSS title key or any other information indicating that the medium is protected using the VCPS content protection system. The respective check can be made either by directly accessing predetermined sectors of the storage medium, or by analyzing the file system of the storage medium.

For example, it may be assumed that the storage medium is VCPS protected, if the DISC.CSS file or the VTS_{—}[0 . . . 9][1 . . . 9]_{—}[0].CSS file (as described above) is present on the storage medium.

If it is found in step 720 that no VCPS information is present on the storage medium, access is granted in a step 730 to a data content on the medium provided a content protection system, which may optionally be present on the medium, grants access to the medium. In other words, if the storage medium is a read-only medium and no VCPS information is present on the storage medium, a DVD media reader grants access to the data content stored on the media under the conditions defined by any other content protection systems present on the medium (e.g. the CSS content scrambling system). This option is important to maintain backward compatibility with old read-only media merely comprising a CSS content protection. Thus, even a media player using the inventive algorithm 700 will be able to give access to a non-VCPS-protected conventional medium, which is important for a user acceptance of the inventive content protection system and the inventive media players.

However, if according to step 710 the storage medium is a read-only medium, and according to step 720 VCPS information is present on the storage medium, an additional authorization is required to allow access to a storage medium according to the inventive method 700. In this case, in a step 740 a VCPS authorization will be required. Access to the data content stored on the storage medium is granted only if the VCPS authentication is successful, i.e. if the VCPS information on the medium allows access to the medium.

Thus, if according to step 720 VCPS information is identified on a read-only storage medium, the inventive method 700 prevents access to the data content on the media if the VCPS authentification is not successful. In other words, it is preferred that in an optional step 750 the inventive algorithm 700 prevents (or denies) access to the CSS key-related information not encrypted using the VCPS method, if VCPS information is found to be present on the medium in step 720.

The described mechanism is an important feature for media comprising both CSS and VCPS content protection information. Without using the inventive algorithm 700, access could be granted to the storage media merely using the information encrypted using the CSS cryptographic method, which has be founded to be not sufficiently secure. Thus, without using the inventive algorithm 700, a CSS+VCPS protected medium could be hacked merely based on the CSS information, which is required for backward compatibility with conventional playback devices.

However, if it is found in a step 720 that information related to a cryptographically more secure method (e.g. VCPS) is present on the medium, no further access is given to key related information of the cryptographically less secure encryption method (e.g. CSS).

Consequently, if the inventive algorithm 700 is implemented in a large number of media player devices on the market, the playback of media comprising both a weak (e.g. CSS) and a strong (e.g. VCPS) content protection mechanism can only be performed successfully when an authentication of the strong (VCPS) content protection mechanism is successful. Therefore, media player devices implementing the inventive algorithm inclusive of the optional step 750 for preventing access to CSS key related information can help to ensure that copyrights are obeyed.

If, on the other hand in step 710 it is found that the storage medium is not a read-only medium, i.e. the storage medium is writeable or a re-writeable medium, it is checked in a further step 760, whether the data stored on the medium is protected using a VCPS method. The step 760 therefore comprises checking whether VCPS information is present on the storage medium, similar to the check executed in step 720. If it is found that the data stored on the medium is protected using the VCPS method, i.e. VCPS related information is present on the storage medium, access to the data content stored on the medium is provided if the VCPS information allows access to the medium. In other words, if it is found in step 760 that data stored on a medium is protected using the VCPS method, access to the data content stored in the medium is only granted in the step 770 if a VCPS authentification is successful. In contrast, if the VCPS authentification is not successful, access to the data content on the storage medium is refused, or an incorrect key is provided for a decryption of the encrypted data content on the storage medium.

Further, if the data stored on the medium is protected using the VCPS method, optionally any CSS key related information present on the medium may be withheld in a step 780. In other words, access to CSS key related information, which may be present on the storage medium (e.g. provided intentionally for maintaining compatibility of the medium with conventional playback devices, or originating from an illegal copying a copyrighted read-only medium), is optionally prevented in step 780, if it is found out in step 760 that any VCPS-related information is present on the storage medium. In other words, if it is found in step 760 that a cryptographically more secure cryptographic method is used to protect the content on the storage medium, access to key related information on the medium dedicated to a cryptographically less secure cryptographic method is blocked, so that an access to the data content on the storage medium is merely possible by using the cryptographically more advanced or more secure cryptographic method. In this way it can be prevented that an unauthorized offender of the copyright protection, storing on the writeable medium (as detected in step 710) any additional non-secure content protection information (other than VCPS content protection, which is considered to be secure) in an attempt to convince a media player device to use the cryptographically less secure information (which the offender may have produced in an illegal or unauthorized way), will have success.

If in step 760 it is detected that the data content on the storage medium is not protected using the VCPS method, access to the data content stored on the storage medium is granted only if a data content protection mechanism out of a set of data protection mechanisms considered to be insecure is not present on the storage medium. In other words, it is for example checked whether information related to a content protection system considered insecure is present on the medium. As according to the present invention it is not allowable to store on the user-writeable storage medium a data content using a cryptographically weak cryptographic method, access to the data content on the storage medium is denied in step 790, if an indication is found indicating that a cryptographically weak method is used to encrypt the data content.

For example, in step 790 it can be checked whether any key information related to a cryptographically weak encryption algorithm is present on the storage medium. For example within the method 700 a database may be available describing a number of cryptographically weak decryption algorithms which may not be used for writeable or re-writeable media. Thus, a check is performed to the storage medium in order to find out as to whether any of the key information used by algorithms known to be cryptographically weak is present. Thus, for a list of known cryptographically weak algorithms the respective checks are performed. For example, it may be checked whether any of the CSS key information is present on the storage medium in the step 790, and access to the data content on the storage medium may be refused, because it is defined that a storage medium containing CSS content protection may only be produced using a writeable or re-writeable medium, if in addition a VCPS content protection is present on the medium.

Thus, using the method 700 as described with reference to FIG. 7, a wide range of unauthorized access to the data content of the storage medium can be prevented while backward compatibility with conventional CSS protected read-only storage media is maintained.

For media comprising both CSS and VCPS content protection information, access is granted only via the cryptographically more secure VCPS authorization, while the access to the cryptographically insecure CSS-only protected key-related information is blocked.

Furthermore, a decision is introduced in step 710 whether a storage medium is a read-only medium or a writeable or re-writeable medium, in order to ensure that on a writeable or re-writeable media only a cryptographically secure content protection system is used.

The method 700 described with reference to FIG. 7 can also be amended in that access to the data content on the storage medium is completely rejected, if the storage medium is a writeable or re-writeable medium and the data stored on the medium is not protected using the VCPS content protection method.

Alternatively, if in step 760 it is found that VCPS related information is not present on the VCPS medium, access to any key-related information not protected using VCPS encryption may be refused, as described for steps 750, 780.

Further improvements can be added to a method 700. In particular, if it is found in step 710 that the storage medium is a writeable or re-writeable medium (i.e. that the storage medium is not a read-only medium), and it is further found that the data stored on the medium is protected using the VCPS method, it may further be checked whether a valid watermark out of a set of watermarks is present on the storage medium.

In this context, a watermark is a cryptographic information which is added to the content of a storage medium and which has no noticeable detrimental effect on the data content of the medium, while removing the watermark is not possible (or cryptographically very complex) without destroying the content of the storage medium.

If a valid watermark is not present, for example access to the encrypted data content on the storage medium may be rejected or restricted. For example, a VCPS authentication may be rejected or blocked, if a valid watermark is not found on the storage medium. In other words, the check for a valid watermark may be executed before a VCPS authentication is initiated. Thus access to the medium is only granted if a valid watermark is identified or, optionally, if the medium is empty.

On the other hand, if a valid watermark is found, access to the encrypted data content on the storage medium may be granted or restricted depending on an information encoded by the respective watermark.

For example, the watermark may define that copying of the encrypted content on the storage medium is not allowed, allowed one time, or allowed arbitrarily. On the other hand, if the presence of a valid watermark is not found on the storage medium, access to encrypted data content may be rejected.

In other words, the content protection of the storage medium may be differentiated between a read-only storage media and writeable or re-writeable storage media. While it is technologically rather difficult (at least for an end user) to produce a read-only storage medium violating copy rights, increased requirements with respect to the application of a content protection system should be applied to writeable or re-writeable storage media, as both types can easily be produced by end users or offenders. Thus, a writeable or re-writeable storage medium should only be accepted if a cryptographic content protection method considered to be cryptographically secure is applied to protect the encrypted data content thereon.

To summarize the above, it can be stated that an inventive system uses the VCPS media that will come to the market in the following months. VCPS technology is based on VCPS media, media that carry unique key information useful only for adopters of VCPS. VCPS is also based on a dedicated DVD recorder able to read key information carried by a VCPS media. VCPS is further based on a dedicated computer software which knows a special protocol to achieve key information carried by the media from the DVD recorder. The dedicated computer software further knows secret information that allow it to interpret the key information. Using VCPS technologies, a 128 bit disc key can be calculated. This key is unique to each VCPS media.

In contrast, the conventional content scrambling system CSS is based on a set of title keys and a disc key. Each video title set on a DVD video is assigned a unique title key. One disc key exists per media.

One of the essential concepts of the described system and concept is that the CSS keys can be accessed both through CSS and VCPS. During CSS authentication, CSS keys are retrieved from the media through the drive by means of the dedicated comment set. The system stores CSS keys in the user data area.

In addition to each media title set, consisting of files named after the scheme VTS_{—}[0 . . . 9][1 . . . 9]_{—}[0 . . . 9].{IFO/VOB/BUP}, a file named VTS_[0 . . . 9][1 . . . 9]_{—}[0].CSS is generated, containing the corresponding CSS title key in an encrypted form. The root directory of such a DVD video contains a file named DISC.CSS containing the encrypted disc key.

A system capable of reading CSS protected discs using VCPS authentication will first authenticate with VCPS and obtain the 128 bit VCPS disc key. This VCPS disc key is then used to decrypt the files VTS_{—}[0 . . . 9][1 . . . 9]_{—}[0].CSS and DISC.CSS to obtain the CSS keys.

A DVD video media for example consists of multiple sectors each comprising 2048 bytes of data. A title set contained on a DVD video media consists of multiple sectors. When a device hasn't successfully authenticated a computer playback software, it does not grant access to sectors belonging to an encrypted title set.

A player supporting VCPS authentication must therefore, up on completing VCPS authentication, grant read access to title key protected sectors to completely replace legacy CSS authentication. Content is then read from the media using standard READ commands according to the MMC command set that are sent over a bus connecting the recorder device and the host. Sectors can be accessed at random. This means that only the sectors that are needed for playback of a portion of video selected by the users are read from the media. If a sector that belongs to an encrypted title set is read, it needs to be decoded using a corresponding CSS title key. A corresponding CSS title key obtained by reading a particular VTS_{—}[0 . . . 9][1 . . . 9]_{—}[0].CSS file and decrypting the file by means of the VCPS disc key is therefore used to decrypt an encrypted sector of a DVD video media.

In order to understand the advantages of the present invention, it should be pointed out that continuous attempts by hackers to get access to copy protected material has led to a situation where the CSS copy protection technology used to protect DVD video contents has become little helpful to thwart efforts to copy DVD video content. The original CSS specification does not provide an upgrade path to direct the technological problems that are inherent in CSS and allow the copy protection to be hacked. The inventive method and system described in this document provides an upgrade path for newly produced DVD media and players by combining two copy protection technologies: CSS (content scrambling system) and VCPS (video content protection system). It is the purpose of the inventive system and method to provide an alternative to CSS authentication to obtain the keys used for CSS (data content) encryption. It is further the purpose of the inventive system to substitute CSS authentication by the inventive new authentication and content protection system for all new playback and recording devices. Legacy playback devices will continue to use CSS information stored on those discs and therefore play content successfully.

In this way the inventive content protection concept overcomes the structural weaknesses of CSS and the fact that media being protected using the VCPS content protection system exclusively cannot be played on legacy playback devices which only supports CSS but do not support VCPS copy protection. Thus, the present invention creates a hybrid solution which is needed to provide an upgrade path for new DVD players to use secure encryption while legacy players may still use CSS protected media. Pirated media will therefore play on a degreasing amount of players, namely all players that have been produced before a certain day X until all legacy players have been phased out of the market.

In other words, it is assumed that conventional (legacy) DVD players can only play media which comprises all the cryptographic information as defined by the CSS standard. In contrast, new inventive players are assumed to play old conventional media comprising only information outlined in the CSS specification, media comprising the hybrid information as described with reference to FIG. 3, and media comprising exclusively the information outlined in the VCPS standard. On the other hand, three types of media are considered, namely media comprising only the information outlined in the CSS specification, media comprising the inventive hybrid information according to FIG. 3, and media comprising only the information outlined in the VCPS specification.

The first type of media, also designated as CSS-only media, will play both on conventional media players and inventive media players, but this media are not cryptographically secure, and it is therefore not desirable to continue producing such media. Thus, it may be assumed that such media will disappear from the market.

The inventive media comprising information described with reference to FIG. 3 comprise both any information required according to the CSS specification, and further comprise the hybrid information as described (e.g. the VCPS-encrypted and CSS-encrypted CSS title key and the VCPS-encrypted CSS disc key). Thus, the hybrid media will play on both old, conventional players and the new inventive players. The hybrid media comprise the risk that using an old player, the CSS only encrypted information can be obtained, so that the content of the inventive hybrid media can be obtained by a hacker using an old media player. However, inventive modern media players will recognize hybrid media and will find out that the hybrid media comprise VCPS related information. Therefore, the new inventive player will reject access to the conventional CSS information, thus preventing an attack to obtain the media content without authorization by hacking the cryptographically insecure CSS method. Therefore, although copyrighted information can illegally be obtained from the inventive hybrid media using conventional players, the copyrighted information on the inventive hybrid media is secure as soon as the conventional media players have been phased out of the market and been replaced by inventive media players.

Also, as soon as a sufficient number of the new inventive media players are on the market which can play all the described media type, new media may be produced only comprising VCPS content protection without the inventive hybrid CSS plus VCPS content protection. At this time, there is no more chance to attack the VCPS-only encrypted media (no longer containing CSS related information), as those are cryptographically secure.

To summarize the above, the inventive CSS+VCPS hybrid solution is a concept to handle a transition from the conventional CSS-only protected media to the VCPS-only protected media fulfilling the VCPS specification.

In other words, the present invention creates a system and method for encrypting the data content of DVD video discs. The system and method for encrypting the content on a DVD video disc produces a DVD video disc such that the resulting disc is compatible with existing DVD players. The inventive system at the same time makes new DVD players more secure by introducing an alternative protection against hacking. According to the present invention, keys used by one content protection system (CSS) are encrypted using the secret keys of another content protection system (VCPS). According to the present invention, the second content protection system (VCPS) is (cryptographically) more secure than the first content protection system, and allows to provide an upgrade path for broken content protection systems. According to the present invention, compatibility with legacy DVD players supporting only the broken content protection system (CSS) is maintained. Keys of a broken content protection system (CSS) are stored in the user data area of a DVD video disc. The keys of the broken content protection system are stored so that they can be decrypted only by devices licensing another content protection technology (VCPS). According to the present invention, the other content protection technology (VCPS) may therefore replace the broken content protection system (CSS) in new versions of playback devices.

Depending on certain implementation requirements of the inventive methods, the inventive methods can be implemented in hardware or in software. The implementation can be performed using a digital storage medium, for example a disk, DVD, CD, ROM, PROM, EPROM, EEPROM or FLASH, having electronically readable control signals stored thereon, which cooperate with a programmable computer system such that the inventive methods are performed. Generally, the present invention is, therefore, a computer program product with a program code stored on a machine readable carrier, the program code being operative for performing the inventive methods when the computer program product runs on a computer. In other words, the inventive methods are, therefore, a computer program having a program code for performing at least one of the inventive methods when the computer program runs on a computer.

Besides, it should be noted that the above mentioned concept of binding a data content to a media using a watermark can be used independent of the described CSS-VCPS hybrid method. In other words, the concept of binding the data content to the media may be used for reading or writing a pure CSS media, a pure VCPS media or any other media making use of one or more cryptographic methods.

It is the key idea of the mentioned concept to include into the data content (or the overall content of the media) a watermark representing a key which is bound to the media, i.e. which is for example either prewritten to the media, or which is adapted to be written to the media independent of the data content. For example, the key may be based on a random number generated in a media writer hardware, and which can not be selected by a user writing the data content.

The watermark may be evaluated when reading the data content from the media in order to ensure that the data content is bound to the media to which it was originally written.

In other words, in a general embodiment of a procedure for writing a data content to a media, the data content (or an encrypted data content) is produced such that the data content (or the encrypted data content) comprises a watermark, the watermark representing (or encoding) a key information or an intermediate key information which is bound to the media.

For example, the watermark may represent (or encode) a key used for encrypting the data content, or an intermediate key information, like a CSS disc key, a CSS title key, a VCPS unique ID, a VCPS disc key, a VCPS unique key or a VCPS program key, provided the information is bound to a media.

A media implementing the described concept may comprise a key information bound to the media and a data content comprising a watermark, the watermark representing (or encoding) the key information bound to the media.

Further, a general method of reading a data content from a media comprises extracting an information from a watermark of the data content and comparing the information of the watermark with a key information or an intermediate key information bound to the media. If the information of the watermark is not identical to the key information or the intermediate key information, the method of reading may abort, or restrict or deny access to the data content.

The present invention creates a user friendly concept for providing an upgrade path for DVD video copy protection, which gives the music industry a chance to improve the enforcement of the copyrights without excluding users of older equipment from a use of legally obtained media.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A method of writing decryption information to a storage medium for storing an encrypted data content, the encrypted data content being encrypted, using a data content key, for decrypting the encrypted data content using a first encryption method, the method comprising the steps of:
encrypting the data content key or a first-method-encrypted data content key using a second cryptographic method which is different from the first cryptographic method, to obtain a second-method-encrypted data content key; and
storing on the medium the second-method-encrypted data content key,
wherein the method of writing is operative to produce the storage medium such that it includes:
the encrypted data, encrypted with the data content key and the first cryptographic method;
the first-cryptographic-method-encrypted data content key; and
the second-cryptographic-method-encrypted data content key.

2. The method of claim 1, wherein the first cryptographic method comprises a first cryptographic algorithm for encrypting and/or decrypting the encrypted data content using the data content key, and a second cryptographic algorithm for encrypting and/or decrypting the data content key, wherein the second cryptographic algorithm is different from the first cryptographic algorithm; and
wherein the second cryptographic method comprises a cryptographic algorithm for encrypting and/or decrypting the data content key or the first-method-encrypted data content key to obtain the second-method-encrypted data content key.

3. The method of claim 2, wherein the second cryptographic algorithm of the first cryptographic method uses a first-cryptographic-method media key, and wherein the algorithm for encrypting and/or decrypting the data content key or the first-method-encrypted data content key uses a second-cryptographic-method media key.

4. The method of claim 2, wherein the algorithm for encrypting and/or decrypting the data content key or the first-method-encrypted data content key is cryptographically more secure than the second encryption algorithm of the first cryptographic method.

5. The method of claim 1, wherein the second cryptographic method is cryptographically more secure than the first cryptographic method.

6. The method of claim 1, wherein the first cryptographic method is a CSS method, wherein the second cryptographic method is a VCPS method,
wherein the first algorithm is a CSS data encryption or decryption algorithm, wherein the second algorithm is a CSS key encryption or decryption algorithm; and
wherein the algorithm for encrypting or decrypting the data content key or the first-method-encrypted data content key is a VCPS encryption or decryption algorithm.

7. The method of claim 1, wherein the first-method-encrypted data content key is encrypted such that it can be decrypted using a first-method media key associated with the storage medium, the method further comprising:
encrypting the first-method media key such that it can be decrypted using a second-cryptographic-method media key associated with the storage medium, to obtain a second-method-encrypted first-method media key; and
storing the second-method-encrypted first-method media key on the medium.

8. The method of claim 7, wherein the method of writing is operative to produce the storage medium such that the second-method-encrypted first-method media key is stored in a file accessible through a file system.

9. The method of claim 1, wherein the method of writing is operative to produce the storage medium such that the first-method-encrypted data content key is stored in a sector header of a corresponding sector which it encrypts; and
that the second-method-encrypted data content key is stored in a file accessible through a file system.

10. The method of claim 1, further comprising the steps of:
reading from the storage medium an encrypted, read-only version of the first-method media key, encrypted using a device manufacturer key;
decrypting the device-manufacturer-key-encrypted first-method media key to obtain a decrypted first-method media key;
reading from the storage medium an encrypted, second-method read-only key, encrypted using another device manufacturer key;
decrypting the device-manufacturer-key-encrypted second-method read only key;
obtaining a unique ID number;
combining the decrypted second-method read only key with the unique ID number to obtain the second method media key;
generating the data content key;
encrypting the data content key using the decrypted first-method media key or a key derived using the decrypted first-method media key to obtain the first-method-encrypted data content key;
encrypting the decrypted first-method media key using the second-method media key to obtain the second-method-encrypted first-method media key;
storing the second-method-encrypted first-method media key on the storage medium;
encrypting the first-method-encrypted data content key using the second-method media key to obtain the second-method-encrypted data content key; and
storing the second-method-encrypted data content key on the storage medium.

11. The method of claim 1, wherein the method of writing is operative to produce the storage medium such that the data content comprises a watermark representing a key-related information to bind the data content to the media,
the key related information including information specific for an individual media according to the first cryptographic method or the second cryptographic method.

12. A storage medium writer for writing decryption information to a storage medium for storing an encrypted data content, the encrypted data content being encrypted, using a data content key, for decrypting the encrypted data using a first cryptographic method, the storage medium writer comprising:
an encrypter for encrypting the data content key or a first-method-encrypted data content key using a second cryptographic method which is different from the first cryptographic method, to obtain a second-method-encrypted data content key; and
a storage for storing on the medium the second-method-encrypted data content key,
wherein the storage medium writer is adapted to be operative to produce a storage medium such that it includes:
the encrypted data, encrypted with the data content key and the first cryptographic method;
the first-cryptographic-method-encrypted data content key; and
the second-cryptographic-method-encrypted data content key.

13. A storage medium comprising:
an encrypted data content, being encrypted using a data content key such that the data content can be encrypted using a first cryptographic method;
a first-method-encrypted version of the data content key, encrypted such that it can be decrypted using a first-cryptographic-method media key; and
a second-cryptographic-method encrypted data content key, which is an encrypted representation of the data content key or the first-method-encrypted data content key, encrypted such that the data content key or the first-method-encrypted data content key can be derived from the second-method-encrypted data content key using a second-cryptographic-method media key.

14. The storage medium of claim 13, further comprising:
an information from which the first-cryptographic-method media key can be derived; and
an information from which the second-cryptographic-method media key can be derived.

15. The storage medium of claim 14, wherein the information from which the first-cryptographic-method media key can be derived is stored on the medium in a read-only region of the storage medium, and/or
wherein the information from which the second-cryptographic-method media key can be derived is stored in a read only region of the storage medium.

16. The storage medium of claim 13, wherein the first cryptographic method comprises a first cryptographic algorithm for encrypting and/or decrypting the encrypted data using the data content key, and
a second cryptographic algorithm for encrypting and/or decrypting the data content key, wherein the second cryptographic algorithm is different from the first cryptographic algorithm; and
wherein the second cryptographic method comprises a cryptographic algorithm for encrypting and/or decrypting the data content key or the first-method-encrypted data content key to obtain the second-method-encrypted data content key.

17. The storage medium of claim 13, wherein the second cryptographic algorithm of the first cryptographic method uses the first-method media key, and
wherein the second-cryptographic-method algorithm for encrypting and/or decrypting the data content key or the first-method-encrypted data content key uses the second-cryptographic-method media key.

18. The storage medium of claim 13, wherein the algorithm for encrypting and/or decrypting the data content key or the encrypted data content key is cryptographically more secure than the second cryptographic algorithm of the first cryptographic method.

19. The storage medium of claim 13, further comprising a first read-only structure comprising a plurality of manufacturer-key-encrypted first-method media keys, which can be decrypted by a storage medium reader using a secret information, to obtain the first method media key; and
a second read-only structure comprising a plurality of manufacturer-key-encrypted second-method root keys, which can be decrypted by a storage medium reader using another secret information, to derive therefrom the second-method media key.

20. The storage medium of claim 13, wherein the encrypted data content is contained in one or more sectors of the storage medium,
wherein the first-method-encrypted data content key is contained in a sector header of at least one of said sectors of the storage medium; and
wherein the second-method-encrypted data content key is stored in a dedicated file, which is registered in a media content directory of the storage medium and has an associated predetermined file name.

21. The storage medium of claim 13, further comprising:
a second-method-encrypted first-method media key, wherein the second-method-encrypted first-method media key is adapted to be decrypted using the second-method media key to obtain a decrypted representation of the first-cryptographic-method media key.

22. The storage medium of claim 21, wherein the second-method-encrypted first-method media key is contained in a dedicated file, which is registered in a media content directory of the storage medium and has an associated predetermined file name.

23. The storage medium of claim 13, wherein the first method is a CSS method, and the second method is a VCPS method.

24. The storage medium of claim 13, wherein the data content comprises a watermark representing a key-related information to bind the data content to the media,
the key related information including information specific for an individual storage media according to the first cryptographic method or the second cryptographic method.

25. A method of reading data from a storage medium for storing an encrypted data content, the encrypted data content being encrypted, using a data content key, for decrypting the encrypted data using a first encryption method, a first-cryptographic-method-encrypted data content key, and a second-cryptographic-method-encrypted data content key or a first-cryptographic-method-encrypted and second-cryptographic-method-encrypted data content key, the method comprising the steps of:
checking, whether the storage medium is recorded using a first recording method or using a second recording method; and
if the storage medium is recorded using the first recording method, recovering the data content key using a second-cryptographic-method media key, and decrypting the encrypted data content using the first cryptographic method and the data content key recovered using the second cryptographic method.

26. The method of claim 25, further comprising:
checking, whether the storage medium comprises key information for use with the second cryptographic method and, if so, blocking access to a first-cryptographic-method key information which is not encrypted using the second cryptographic method.

27. The method of claim 25, further comprising the following steps, if the storage medium is recorded using the second recording method:
checking, whether a second-cryptographic-method information is present on the storage medium;
recovering the data content by determining, using the first cryptographic method, the first-cryptographic-method media key, by determining, using the first-cryptographic-method media key, the first-cryptographic-method content key, and by decrypting the encrypted data content using the first-cryptographic-method, provided a second encryption method information is not present on the storage medium; and
recovering the data content by obtaining the second-cryptographic-method media key, provided second-cryptographic-method information is present on the storage medium.

28. The method of claim 25, wherein recovering the data content key comprises:
decrypting a second-cryptographic-method-encrypted data content key using a second-cryptographic-method media key to obtain the plain text data content key.

29. The method of claim 25, wherein recovering the data content key comprises:
decrypting the second-cryptographic-method encrypted and first-cryptographic-method encrypted data content key using the second-cryptographic-method media key to obtain a second-method-derived first-cryptographic-method-encrypted data content key;
decrypting the second-cryptographic-method-encrypted first-cryptographic-method media key using the second-cryptographic-method media key to obtain a second-cryptographic-method-derived first-cryptographic-method media key; and
decrypting the second-method-derived first-method-encrypted data content key using the second-method-derived first-method media key to obtain the second-method-derived data content key.

30. The method of claim 25, wherein the second recording method is a read-only medium recording method, and wherein the first recording method is a writeable-medium recording method.

31. The method of claim 25, further comprising the step of:
denying access to the data content on the storage medium if second-cryptographic-method information is present on the storage medium and a second-cryptographic-method authentication fails.

32. The method of claim 31, wherein denying access to the data content on the storage medium comprises denying access to the encrypted data content or denying access to the first-cryptographic-method key information.

33. The method of claim 25, further comprising the step of checking, whether a valid watermark out of a set of at least one watermarks is present on the storage medium, and restricting access to the data content on the storage medium depending on whether a watermark is present on the storage medium.

34. The method of claim 33, wherein access is granted to the data content on the storage medium only if the medium a valid watermark is identified on the storage medium.

35. The method of claim 33, wherein access to the data content on the storage medium is restricted depending on an information contained in the watermark, if a watermark is present on the storage medium.

36. The method of claim 33, wherein the step of restricting access comprises denying access.

37. The method of claim 33, wherein the step of restricting access comprises suppressing output information which is usable for digital copying of the data content on the storage medium.

38. The method of claim 25, further comprising checking, whether a valid watermark representing a unique key of the storage medium is present on the storage medium, and restricting access to the data content on the storage medium depending on whether the valid watermark is present on the storage medium or not.

39. The method of claim 38, wherein the step of checking comprises:
identifying a watermark in an encrypted data content of the storage media or a plain text data content of the storage media;
extracting a watermark information from the watermark;
comparing the watermark information with a unique information which is used for deriving a first-cryptographic-method key information or a second-cryptographic-method key information; and
restricting access to the data content on the storage medium, if the watermark information does not describe the first-cryptographic-method key information or the second-cryptographic-method key information.

40. A storage medium reader for reading data from a storage medium for storing an encrypted data content being encrypted, using a data content key, for decrypting the encrypted data using a first encryption method, a first-cryptographic-method-encrypted data content key, and a second-cryptographic-method-encrypted data content key or a second-cryptographic method-encrypted and first-cryptographic-method encrypted data content key, the storage medium reader comprising:
a checker for checking, whether the storage medium is recorded using a first recording method or using a second recording method;
a recoverer for recovering the data content key using a second-encryption-method media key, if the storage medium is recorded using the first recording method; and
a decrypter for decrypting the encrypted data content using the first encryption method and the recovered data content key.

41. A computer program for executing a method of writing decryption information to a storage medium for storing an encrypted data content, the encrypted data content being encrypted, using a data content key, for decrypting the encrypted data content using a first encryption method, the method comprising the steps of:
encrypting the data content key or a first-method-encrypted data content key using a second cryptographic method which is different from the first cryptographic method, to obtain a second-method-encrypted data content key; and storing on the medium the second-method-encrypted data content key, wherein the method of writing is operative to produce the storage medium such that it includes: the encrypted data, encrypted with the data content key and the first cryptographic method; the first-cryptographic-method-encrypted data content key; and the second-cryptographic-method-encrypted data content key, when the computer program runs on a computer.

42. A computer program for executing a method of reading data from a storage medium for storing an encrypted data content, the encrypted data content being encrypted, using a data content key, for decrypting the encrypted data using a first encryption method, a first-cryptographic-method-encrypted data content key, and a second-cryptographic-method-encrypted data content key or a first-cryptographic-method-encrypted and second-cryptographic-method-encrypted data content key, the method comprising the steps of: checking, whether the storage medium is recorded using a first recording method or using a second recording method; and if the storage medium is recorded using the first recording method, recovering the data content key using a second-cryptographic-method media key, and decrypting the encrypted data content using the first cryptographic method and the data content key recovered using the second cryptographic method, when the computer program runs on a computer.
